(19) United States
(12) Patent Application Publication
(10) Pub. No.: US 2020/0229645 A1
(43) Pub. Date: Jul. 23, 2020

(54) FOOD DELIVERY SYSTEMS, APPARATUSES, AND METHODS

(71) Applicant: GPCP IP Holdings LLC, Atlanta, GA (US)

(72) Inventors: Kyle Robert Karsten, Green Bay, WI (US); Chevis James Watkinson, Appleton, WI (US); Russell William Diamond, Greenville, WI (US); Umberto Scott Stefanini, Madison, WI (US); Jonathan Mark Butzine, Oconomowoc, WI (US); Matthew J. Poster, Madison, WI (US); John Cian Boland, San Francisco, CA (US)

(21) Appl. No.: 16/717,429

(22) Filed: Dec. 17, 2019

Related U.S. Application Data
(60) Provisional application No. 62/794,051, filed on Jan. 18, 2019.

(51) Int. Cl. A47J 41/00; A47J 47/14; A47J 39/00

(52) U.S. Cl. CPC A47J 41/0094; A47J 47/14; A47J 39/006; A47J 39/003; A47J 41/005

(57) ABSTRACT

A food delivery container including a plurality of insulated walls that form a food chamber, and a climate control system. The climate control system includes an air flow pathway and a heating and/or cooling element positioned within the air flow pathway. A fan is in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the cooling and/or heating element to circulate heated/cooled air within the food delivery container. The climate control system also includes a power supply configured to supply electrical power to the fan and the cooling/heating element.

### CROSS-REFERENCE TO RELATED APPLICATION(S)

This application claims priority to U.S. Provisional Application No. 62/794,051, entitled “Food Delivery Systems, Apparatuses, and Methods”, filed Jan. 18, 2019, which is incorporated by reference herein in its entirety.

### BACKGROUND OF THE INVENTION

Insulated food containers (IFCs), such as delivery bags are typically used to transport food products from a restaurant or kitchen to a delivery location. IFCs are generally configured to limit the change in temperature of the food during the delivery. However, some IFCs may be subject to significant heat loss, such as due to long distance deliveries, delays in delivery, or delays in time of consumption. These heat losses may be particularly significant in cold climates. In addition to heat loss, some IFCs may be susceptible to moisture buildup, such as from steam escaping food packages contained therein. The increased moisture may cause undesirable effects on the food products.

### SUMMARY OF THE INVENTION

The present invention generally relates to food containers and, more particularly, relates to food delivery systems, apparatuses, and corresponding methods.

Example embodiments of the present invention provide food delivery systems, apparatuses, and methods that create efficient and effective food delivery services. In some example embodiments, a food delivery system may be provided. The food delivery system may include an insulated food container (IFC) having a plurality of insulated walls forming a food chamber. The food chamber may be climate controlled by one or more climate control systems configured to maintain the temperature of the food chamber, such as in a specified temperature band. The climate control system may be positioned in one of the insulated walls and include an air flow pathway that includes a heating/cooling element disposed therein and a fan in communication with the food chamber through an inlet opening and at least one outlet opening. The fan may be configured to draw in air from the food chamber through the inlet opening and push air into the food chamber through the outlet opening such that air travels through the air flow pathway and over the heating/cooling element to circulate heated/cooled air within the food chamber.

In some example embodiments, a food package support is provided to receive one or more food packages. The food package support may include a plurality of flow holes to enable the heated/cooled air to circulate about the food packages. In some embodiments, the food packages themselves may include one or more concave edges that align with the flow holes of the food package support to maximize air flow about the food packages. In some embodiments, the food packages may be reusable, such as being made from reusable or washable material.

In some example embodiments, the system may be configured to manually or automatically control the temperature band of the IFC using a computing device, such as a smart phone, tablet, or point of sale (POS) device. In some example embodiments, a beacon request may be generated to cause a user interface of the IFC to indicate a selected IFC. In some example embodiments, a boost request may be generated to increase the temperature of the food chamber, such as just prior to (e.g., within 5 minutes of) delivery. The boost request and/or beacon request may be generated manually, such as by interaction with a user interface, or may be generated automatically, such as based on a proximity to a delivery location.

In addition to temperature control, some example embodiments, may include a humidity control element configured to control a moisture content of the volume of air in the food chamber. In an example embodiment, the IFC may be configured to maintain humidity at a predetermined humidity level or in a predetermined humidity band by controlling a flow valve that enables or prevents flow of air through the humidity control element. The humidity control element may reduce moisture build up from food product moisture escape, which may cause undesirable food textures.

In some example embodiments, a power supply of the climate control system may include a rechargeable power supply, such as rechargeable batteries or capacitors. The rechargeable batteries or capacitors may be recharged through a wireless charging element, such as an induction charging coil, or through a wired plug, such as a vehicle DC power plug or AC wall plug.

In some example embodiments, the POS may be integrated into the food delivery system. The system may receive food product information and determine a temperature band for the IFC, for example different temperature hands may be appropriated for soup and pizza. Additionally, the food product information may be used to determine an estimated completion time (e.g., when the food will be ready for insertion into the food delivery container). Accordingly, the food delivery system may cause the IFC to pre-heat to the selected temperature band at the estimated completion time. In some example embodiments, a pre-heat status or beacon request may be generated (such as by providing an alert or notification) to indicate the IFC that is being pre-heated and/or the status of pre-heating the IFC (e.g., pre-heating is complete). In some example embodiments, the food delivery system may also determine an IFC based on a food size of the food products.

In some example embodiments, the food delivery system may be remotely disabled, such that the climate control system does not provide heated air to the food chamber. For example, the climate control system of individual IFCs or groups of IFCs may be disabled when lost or stolen.

In some example embodiments, an identifier reader may be positioned within the food delivery container and configured to identify one or more food packages placed within the food delivery container. In some embodiments, the data read by the identifier reader may identify the food package and/or provide instructions regarding how to operate various aspects of the food delivery container.

In an example embodiment, a food delivery container is provided. The food delivery container comprises a plurality of insulated walls that form a food chamber. At least one of the insulated walls is movable between a closed position and an open position to enable food to be placed within or removed from the food chamber. The food delivery container includes a climate control system positioned within one of the plurality of insulated walls. The climate control system comprises an air flow pathway; a heating element positioned within the air flow pathway; and a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the heating element to circulate heated air within the food delivery container. The food delivery container includes a power supply configured to supply electrical power to the fan and the heating element.

In some embodiments, the food delivery container comprises a temperature sensor configured to measure a temperature of the food chamber; a processor; and a memory. The memory includes computer program code configured to cause the processor to: receive temperature data from the temperature sensor; and control the electrical power supplied to at least one of the fan or the heating element to maintain the temperature of the food chamber either at a first predetermined temperature or within a first predetermined temperature band.

In some embodiments, the food delivery container further includes a position sensor. The computer program code is further configured to cause the processor to: determine a current location based on position data received from the position sensor; determine a delivery location; compare the current location to the delivery location; and, in response to determining that the current location is within a predetermined threshold distance from the delivery location, control the electrical power supplied to at least one of the fan or the heating element to maintain the temperature of the food chamber either at a second predetermined temperature or within a second predetermined temperature band. The second predetermined temperature band is higher than the first predetermined temperature band or the second predetermined temperature is higher than the first predetermined temperature.

In some embodiments, the computer program code is further configured to cause the processor to: receive a boost request from a remote computing device; and control the electrical power supplied to at least one of the fan or the heating element to maintain the temperature of the food chamber either at a second predetermined temperature or within a second predetermined temperature band. The second predetermined temperature band is higher than the first predetermined temperature band or the second predetermined temperature is higher than the first predetermined temperature.

In some embodiments, the computer program code is further configured to cause the processor to: receive a user input defining a food product; determine the first predetermined temperature or the first predetermined temperature band based on the food product; control the electrical power supplied to at least one of the fan or the heating element such that the temperature of the food chamber is either brought to or maintained at the first predetermined temperature or within the first predetermined temperature band; and cause, in response to determining that the temperature of the food chamber has reached the first predetermined temperature or the first predetermined temperature band, an alert or notification to indicate that the temperature of the food chamber has reached the first predetermined temperature or the first predetermined temperature band.

In some embodiments, the computer program code is further configured to cause the processor to: receive a user input defining the first predetermined temperature or the first predetermined temperature hand; determine an estimated completion time corresponding to when the food product will be ready for placement into the food chamber; and control the electrical power supplied to at least one of the fan or the heating element such that the temperature of the food chamber is either at the first predetermined temperature or within the first predetermined temperature band at the estimated completion time.

In some embodiments, the food delivery container further comprises a position sensor. The computer program code is further configured to cause the processor to determine a current location based on position data received from the position sensor. In some embodiments, the computer program code is further configured to cause the processor to: determine a delivery location; compare the current location to the delivery location; and, in response to determining that the current location is within a predetermined threshold distance from the delivery location, cause a user interface of the food delivery container to generate an audio or visual alert.

In some embodiments, the food delivery container further comprises a processor; and a memory including computer program code configured to cause the processor to: receive a beacon request from a remote computing device; and cause a user interface of the food delivery container to generate an audio or visual alert.

In some embodiments, the power supply comprises a rechargeable battery or capacitor that is capable of being recharged and providing electrical power. In some embodiments, the food delivery container further comprises a wireless charging element configured to receive an inductive charge that charges the rechargeable battery or capacitor. In some embodiments, the food delivery container further comprises a wired power supply configured to receive AC or DC power from a power source and charge the rechargeable battery or capacitor. In some embodiments, the power source may be either a vehicle DC power socket or an AC wall socket.

In some embodiments, the food delivery container further comprises a removable liner disposed within the food chamber and configured to contain fluid within the food chamber.

In some embodiments, the food delivery container further comprises at least one heat conductor configured to disperse heat generated by the heating element, rechargeable battery, or capacitor.

In some embodiments, the heating element comprises a resistive heating coil.

In some embodiments, the food delivery container further comprises one or more silicone heating pads disposed on an inner surface of one or more of the plurality of insulated walls. The power supply is further configured to supply electrical power to the one or more silicone heating pads. In some embodiments, the one or more silicone heating pads comprise a first heating pad and a second heating pad, wherein the first heating pad is disposed proximate to a first insulated wall and the second heating pad is disposed proximate to a second insulated wall opposite the first insulated wall. In some embodiments, the air flow pathway further comprises a second outlet positioned within the one of the plurality of insulated walls. The one of the plurality of insulated walls defines a first edge and an opposite second edge, and the first outlet is disposed proximate to the first edge and the second outlet is disposed proximate to the second edge. In some embodiments, the one of the plurality of insulated walls with the climate control systems comprises a top wall of the food chamber.

In some embodiments, the food delivery container further comprises a humidity control element configured to remove or add humidity to a volume of air within the food chamber to maintain either a predetermined humidity level or a predetermined humidity band. In some embodiments, the humidity control element comprises an absorbent cloth, desiccant, rechargeable desiccant, or mixed salts. In some embodiments, the humidity control element comprises a flow valve configured to limit air flow across the humidity control element when the flow valve is in a shut position. The food delivery container further comprises: a humidity sensor configured to measure the humidity of the volume of air within the food chamber; a processor; and a memory. The memory includes computer program code configured to cause the processor to: receive humidity data from the humidity sensor; compare the humidity data to one or more humidity thresholds; and cause the flow valve to be opened when the humidity data exceeds the one or more humidity thresholds or to be closed when the humidity data does not exceed the one or more humidity thresholds.

In some embodiments, the food delivery container further comprises a Food package support configured to be inserted within the food chamber. The food package support comprises a plurality of food package receptacles defined by a plurality of receptacle walls. The plurality of receptacle walls comprises two side walls disposed on opposite sides of the food package support, an upper wall, and lower wall for each of the plurality of food package receptacles. The upper walls and lower walls of the plurality of food package receptacles comprise at least one flow hole enabling air flow through the food package support. In some embodiments, the at least one flow hole is configured to be aligned with the first air outlet opening of the one of the plurality of insulated walls defining the food chamber. In some embodiments, the food package support further comprises a plurality of pinch slots, wherein the plurality of pinch slots are configured to engage a food package to limit opening of the food package when inserted into one of the plurality of food package receptacles. In some embodiments, the upper wall or the lower wall of each of the plurality of food package receptacles comprises one or more ribs configured to engage a complimentary one or more ribs disposed on a bottom or a top of a food package. In some embodiments, the one or more ribs further comprises at least two rib flow holes enabling air flow through the one or more ribs. In some embodiments, the at least one flow hole comprises a plurality of flow holes configured to enable air flow between the plurality of food package receptacles, and wherein the plurality of flow holes are disposed in the upper walls and lower walls of each of the plurality of food package receptacles such that air flows around food packages that each have at least one concave edge.

In some embodiments, the food delivery container further comprises a processor and a memory including computer program code configured to cause the processor to: determine a power supply status; and cause an indication of the power supply status to be displayed on a user interface.

In some embodiments, the fan and the heating element are disposed proximate to a top insulated wall and the power supply is disposed proximate to a bottom insulated wall.

In some embodiments, the food delivery container further comprises an identifier reader configured to read a food package identifier associated with one or more food packages placed within the food chamber; a processor; and a memory including computer program code configured to cause the processor to receive identification data from the identifier reader. In some embodiments, the computer program code is further configured to cause the processor to: determine a first predetermined temperature or a first predetermined temperature band based on the identification data; and cause the food delivery device to control the electrical power supplied to at least one of the fan or the heating element to maintain the temperature of the food chamber either at a first predetermined temperature or within a first predetermined temperature hand. In some embodiments, the computer program code is further configured to cause the processor to determine an order status based on the identification data by comparing the identification data with a planned order, wherein the planned order includes required meal components corresponding to a customer order scheduled for delivery using the food delivery container. In some embodiments, the computer program code is further configured to cause the processor to cause a user interface associated with the food delivery container to indicate the order status. In some embodiments, the computer program code is further configured to cause the processor to cause the order status to be transmitted to a remote computing device. In some embodiments, the identifier reader comprises one of a barcode reader, a QR code reader, a character reader, an RFID reader, or an energy quality reader.

In some embodiments, the food delivery container further comprises one or more wall projections extending from at least one of the plurality of insulated walls into the food chamber, wherein the one or more wall projections are configured to enable complementary food packaging to be placed into the food chamber and limit or prevent non-complementary food packaging from being placed into the food chamber. In some embodiments, the one or more wall projections are configured to channel heated air through the respective one or more wall projections. In some embodiments, the one or more wall projections are aligned with the first inlet opening or the first outlet opening. In some embodiments, the one or more wall projections comprise one or more flow holes configured to enable air flow from the wall projection into the food chamber.

In another example embodiment, a system is provided. The system comprises a food delivery container comprising a plurality of insulated walls that form a food chamber, wherein at least one of the insulated walls is movable between a closed position and an open position to enable food to be placed within or removed from the food chamber. The food delivery container further includes a temperature sensor configured to measure a temperature of the food chamber and a climate control system positioned within one of the plurality of insulated walls. The climate control system comprises an air flow pathway; a heating element positioned within the air flow pathway; and a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the heating element to circulate heated air within the food delivery container. The food delivery container further comprises a power supply configured to supply electrical power to the fan and the heating element. The system further comprises an application module stored on a computing device, wherein the computing device comprises a processor and a memory including computer program code configured to cause the processor to: receive temperature data from the temperature sensor; and cause the food delivery container to control the electrical power supplied to at least one of the fan or the heating element to maintain the temperature of the food chamber at a first predetermined temperature or within a first predetermined temperature band.

In some embodiments, the computing device comprises a computing device that is separate from the food delivery container.

In some embodiments, the computing device comprises a point of sale computing device.

In some embodiments, the computing device comprises a mobile computing device.

In some embodiments, the system further comprises a position sensor positioned relative to the food delivery container and configured to determine the current location of the food delivery container, and the computer program code is further configured to cause the processor to determine a current location based on position data received from the position sensor. In some embodiments, the computer program code is further configured to cause the processor to: determine a delivery location; compare the current location to the delivery location; and, in response to determining that the current location is within a predetermined threshold distance from the delivery location, cause a boost request to be transmitted to the food delivery container. The boost request causes the food delivery container to control the electrical power supplied to at least one of the fan or the heating element to maintain the temperature of the food chamber at a second predetermined temperature or within a second predetermined temperature hand. The second predetermined temperature is higher than the first predetermined temperature or the second predetermined temperature band is higher than the first predetermined temperature band. In some embodiments, the computer program code is further configured to cause the processor to: determine a delivery location; compare the current location to the delivery location; and, in response to determining that the current location is within a predetermined threshold distance from the delivery location, cause a beacon request to be transmitted to the food delivery container. The beacon request causes the food delivery container to cause a user interface to generate an audio or visual alert.

In yet another example embodiment, a method for controlling a food delivery container is provided. The method comprises receiving temperature data from a temperature sensor configured to measure a temperature of a food chamber of the food delivery container. The food delivery container comprises a plurality of insulated walls forming the food chamber. At least one of the insulated walls is moveable between a closed position and an open position to enable food to be placed within or removed from the food chamber. The food delivery container further comprises a climate control system positioned within one of the plurality of insulated walls. The climate control system comprises an air flow pathway, a heating element positioned within the air flow pathway, and a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the heating element to circulate heated air within the food delivery container. The food delivery container further includes a power supply configured to supply electrical power to the fan and heating element. The method comprises controlling the electrical power supplied to at least one of the fan or the heating element to maintain the temperature of the food chamber at a first predetermined temperature or within a first predetermined temperature band.

In yet another example embodiment, a food package support for a food chamber of a food delivery container is provided. The food package support comprises a plurality of food package receptacles defined by a plurality of receptacle walls. The plurality of receptacle walls comprises two side walls disposed on opposite sides of the food package support, an upper wall, and a lower wall for each of the plurality of food package receptacles. The upper walls and the lower walls of the plurality of food package receptacles comprise a plurality of flow holes that enable heated air flow through the food chamber. When the food package support is inserted into the food chamber, a first one of the plurality of flow holes is configured to align with a first air outlet of an air flow pathway of a climate control system.

In some embodiments, the air flow pathway of the climate control system further comprises a second air outlet opening. When the food package support is inserted into the food chamber, a second one of the plurality of flow holes is configured to align with the second air outlet of the air flow pathway.

In yet another example embodiment, a food package is provided. The food package comprises a food receiving portion comprising a first mating surface about a periphery of the food receiving portion; a lid comprising a second mating surface that aligns with and interacts with the first mating surface of the food receiving portion when the food package is closed; and a plurality of package projections extending from each corner of one of the food receiving portion or the lid so as to define flow pathways between consecutive package projections to enable heated air flow around the food package.

In some embodiments, the food package further comprises one or more ribs disposed on the food receiving portion or the lid. The one or more ribs are configured to engage a complementary one or more ribs disposed in a food package support.

In some embodiments, the food package further comprises a recess or projection disposed on the food receiving portion configured to engage a complementary projection or recess in the lid.

In yet another example embodiment, a system is provided. The system comprises a food delivery container comprising a plurality of insulated walls that form a food chamber, wherein at least one of the insulated walls is movable between a closed position and an open position to enable food to be placed within or removed from the food chamber. The food delivery container further includes a climate control system positioned within one of the plurality of insulated walls. The climate control system comprises an air flow pathway; a heating element positioned within the air flow pathway; a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the heating element to circulate heated air within the food delivery container. The food delivery container further includes a power supply configured to supply electrical power to the fan and the heating element. The system further includes a food package support comprising: a plurality of food package receptacles defined by a plurality of receptacle walls. The plurality of receptacle walls comprises two side walls disposed on opposite sides of the food package support, an upper wall, and a lower wall for each of the plurality of food package receptacles. The upper wall and the lower walls of the plurality of food package receptacles comprise a plurality of flow holes such that when the food package support is inserted into the food delivery container the plurality of flow holes enable heated air flow through the food chamber.

In yet another example embodiment, a system is provided. The system comprises a plurality of food delivery containers. Each of the food delivery containers comprises a plurality of insulated walls that form a food chamber, wherein at least one of the insulated walls is movable between a closed position and an open position to enable food to be placed within or removed from the food chamber. The system further comprises a user interface and an application module stored on a computing device. The computing device comprises a processor; and a memory including computer program code configured to cause the processor to: determine a delivery location corresponding to one of the plurality of food delivery containers; determine a current location corresponding to the one of the plurality of food delivery containers; compare the current location to the delivery location; and, in response to determining that the current location is within a predetermined threshold distance from the delivery location, cause a beacon request to be transmitted to the one of the plurality of food delivery containers to cause the user interface of the one of the plurality of food delivery containers to generate an audio or visual alert to enable audio or visual determination as to which of the plurality of food delivery containers corresponds to the delivery location.

In yet another example embodiment, a system is provided. The system comprises a plurality of food delivery containers. Each of the plurality of food delivery containers comprises a plurality of insulated walls that form a food chamber, wherein at least one of the insulated walls is movable between a closed position and an open position to enable food to be placed within or removed from the food chamber. The system further comprises a user interface and a point of sale (POS) device positioned remotely from the plurality of food delivery containers. The POS device comprises a POS processor and a POS memory including computer program code configured to cause the POS processor to receive a user input defining a food product. The system further comprises an application module configured to receive an indication of the food product and generate a request for a first one of the plurality of food delivery containers to cause the user interface of the first one of the plurality of food delivery containers to generate an audio or visual alert.

In some embodiments, the computer program code is further configured to cause the processor to determine the first one of the plurality of food delivery containers based on a food size associated with the food product.

In some embodiments, the first one of the plurality of food delivery containers further comprises a climate control system configured to maintain a temperature or a temperature band within the food chamber. The application module is further configured to determine a first predetermined temperature or a first predetermined temperature band based on the food product; and cause the first one of the plurality of food delivery containers to heat the food chamber to the first predetermined temperature or within the first predetermined temperature hand. In some embodiments, the application module is further configured to: determine an estimated completion time for the food product; and cause the first one of the plurality of food delivery containers to heat the food chamber to the first predetermined temperature or within the first predetermined temperature band before or at the estimated completion time.

In yet another example embodiment, a food delivery container is provided. The food delivery container comprises a plurality of insulated walls that form a food chamber, wherein at least one of the insulated walls is movable between a closed position and an open position to enable food to be placed within or removed from the food chamber. The food delivery container further includes an identifier reader configured to read a food package identifier associated with one or more food packages placed within the food chamber. The food delivery container further comprises a processor and a memory including computer program code configured to cause the processor to: receive identification data from the identifier reader; and determine an order status based on the identification data.

In some embodiments, the identifier reader comprises one of a barcode reader, a QR code reader, a character reader, or an RFID reader.

In some embodiments, the computer program code is further configured to cause the processor to cause a user interface associated with the food delivery container to indicate the order status.

In some embodiments, the computer program code is further configured to cause the processor to cause the order status to be transmitted to a remote computing device.

In yet another example embodiment, a food delivery container is provided. The food delivery container comprises a plurality of insulated walls that form a food chamber, wherein at least one of the insulated walls is movable between a closed position and an open position to enable food to be placed within or removed from the food chamber. The food delivery container further includes a climate control system positioned within one of the plurality of insulated walls. The climate control system comprises an air flow pathway; a cooling element positioned within the air flow pathway; and a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the cooling element to circulate cooled air within the food delivery container. The food delivery container further includes a power supply configured to supply electrical power to the fan and the cooling element.

In yet another example embodiment, a food delivery container is provided. The food delivery container comprises a plurality of insulated walls that form a food chamber, wherein at least one of the insulated walls is movable between a closed position and an open position to enable food to be placed within or removed from the food chamber. The food delivery container further includes a climate control system positioned within one of the plurality of insulated walls. The climate control system comprises: an air flow pathway; a temperature element positioned within the air flow pathway; and a fan in air flow communication with the food chamber through a first inlet opening and a first outlet opening in the one of the plurality of insulated walls. The fan is configured to draw in air from the food chamber through the first inlet opening and push air into the food chamber through the first outlet opening such that air travels through the air flow pathway and over the temperature element to circulate heated or cooled air within the food delivery container. The food delivery container further includes a power supply configured to supply electrical power to the fan and the temperature element.

In some embodiments, the temperature element comprises a thermoelectric generator.

In some embodiments, the temperature element comprises a Peltier plate.

In some embodiments, the food delivery container further comprises a temperature sensor configured to measure a temperature of the food chamber; a processor; and a memory including computer program code configured to cause the processor to: receive temperature data from the temperature sensor; and control the electrical power supplied to at least one of the fan or the temperature element to maintain the temperature of the food chamber either at a first predetermined temperature or within a first predetermined temperature band.

In yet another example embodiment, a food delivery container is provided. The food delivery container comprises a plurality of insulated walls that form a food chamber, wherein at least one of the insulated walls is movable between a closed position and an open position to enable food to be placed within or removed from the food chamber. The food chamber comprises a first compartment and a second compartment. The food delivery container further includes a climate control system positioned within one of the plurality of insulated walls. The climate control system comprises a cool air flow pathway and a heated air flow pathway; a cooling element positioned within the cool air flow pathway; a heating element position within the heated air flow pathway; a first fan; and a second fan. The first fan is in air flow communication with the first compartment of the food chamber through a first inlet opening and a first outlet opening in the one of the plurality of insulated walls. The first fan is configured to draw in air from the first compartment of the food chamber through the first inlet opening and push air into the first compartment of the food chamber through the first outlet opening such that air travels through the cool air flow pathway and over the cooling element to circulate cooled air within the first compartment of the food chamber. The second fan is in air flow communication with the second compartment of the food chamber through a second inlet opening and a second outlet opening in the one of the plurality of insulated walls. The second fan is configured to draw in air from the second compartment of the food chamber through the second inlet opening and push air into the second compartment of the food chamber through the second outlet opening such that air travels through the heated air flow pathway and over the heating element to circulate heated air within the second compartment of the food chamber. The food delivery container further includes a power supply configured to supply electrical power to at least one of the first fan, the second fan, the cooling element, or the heating element.

Additional example systems, apparatuses, and methods are described herein.

### BRIEF DESCRIPTION OF THE DRAWINGS

Having thus described the energy monitoring system in general terms, reference will now be made to the accompanying drawings, which are not necessarily drawn to scale, and wherein:

FIG. 1 illustrates an example food delivery container according to some example embodiments;

FIG. 2 illustrates an example food delivery container including a climate control system and maintenance access flaps according to some example embodiments;

FIGS. 3-5 illustrate example food delivery containers including climate control systems according to some example embodiments;

FIG. 6 illustrates a top partially-transparent view of an example food delivery container according to some example embodiments;

FIG. 7 illustrates a bottom partially-transparent view of an example food delivery container according to some example embodiments;

FIG. 8 illustrates a perspective partially-transparent view of an example food delivery container according to some example embodiments;

FIG. 9 illustrates example food packages according to some example embodiments;

FIGS. 10A and 10B illustrate an example of loading food packages into an example food delivery container according to some example embodiments;

FIGS. 10C and 10D illustrate example food chambers for receiving food packages according to some example embodiments;

FIG. 11 illustrates an example partitioned food delivery container according to some example embodiments;

FIG. 12 illustrates a perspective view of an example food package support including example food packages according to some example embodiments;

FIG. 13 illustrates a bottom view of an example food package support and example food packages according to some example embodiments;

FIGS. 14A-14D illustrate various views of an example food package having a plurality of ribs according to some example embodiments;

FIGS. 15A-15C illustrate example user interfaces for control of one or more food delivery containers according to some example embodiments;

FIG. 16 illustrates a block diagram of a food delivery system/environment according to some example embodiments;

FIG. 17 illustrates a block diagram of an example apparatus for food delivery within an example food delivery system/environment according to some example embodiments; and

FIG. 18 illustrates an example method of temperature control of a food delivery container according to some example embodiments;

FIG. 19 illustrates an example method of humidity control of a food delivery container according to some example embodiments;

FIG. 20 illustrates an example method of displaying power supply status of a food delivery container according to some example embodiments;

FIG. 21 illustrates an example method of pre-heating a food delivery container according to some example embodiments; and

FIG. 22 illustrates an example method of determining an order status according to some example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true.

As used in herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

### Example Food Delivery Containers

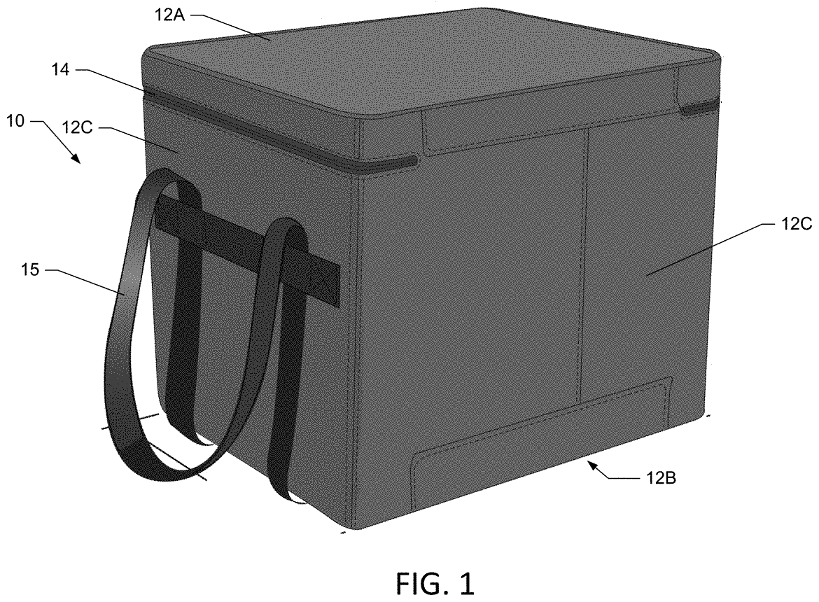

FIG. 1 illustrates an example food delivery container 10 according to some example embodiments. The food delivery container (e.g., an insulated food container (IFC)) 10 may be configured to carry various food products, such as, for example, cans, bottles, deli trays, takeout food packages, sandwiches, food pans, pizzas, or the like. The IFC 10 may include a plurality of insulated walls 12, such as a top wall 12A, a bottom wall 12B, and side walls 12C, forming a food chamber within.

In some embodiments, the insulated walls 12 may be formed from open cell foam insulation or closed cell foam insulation including, but not limited to, polyvinyl chloride (PVC) foam insulation, polyurethane (PU) foam insulation, and polyester foam insulation. The foam insulation may limit or prevent heat transfer from an interior portion of the IFC 10 to the external environment, thereby keeping the food within the IFC 10 hotter for a longer period of time. In some embodiments, the foam insulation may be rigid (e.g., hard or semi-hard), which may provide for a rigid IFC 10. Alternatively, the IFC 10 may include a soft foam, which may provide for the IFC 10 to be collapsible, such as to minimize the IFC 10 volume when not in use.

In addition to the foam insulation, the insulated walls 12 may include an exterior cover material (e.g., fabric), which may protect the foam insulation. The exterior fabric may also be water resistant, preventing moisture entry to the food chamber during delivery, such as in poor weather conditions (e.g., in sleet, snow, or rain). In some examples, the exterior cover material may be a vinyl cover that has low or no breathability for air or moisture. Alternatively, the exterior cover material may be a nylon cover that has a relatively high breathability for both air and moisture, such as to enable steam to escape the IFC to reduce the humidity and moisture within the IFC 10.

The IFC 10 may include at least one insulated wall 12 that is movable between a closed position and an open position to enable food to be placed within or removed from the food chamber. In the depicted embodiment of FIG. 1, the movable insulated wall is shown as the top wall 12A. In some embodiments, other walls (or multiple walls) may be used, such as a side wall 12C. The IFC 10 may include a closure 14 configured to maintain the movable insulated wall 12 in the closed position. The closure 14 may include one or more of a hook-and-loop closure, a zipper closure, a slide release buckle closure, or the like.

The IFC 10 may include one or more carrying elements 15 to enable a user to easily pick up and move the IFC 10. The carrying elements may include, without limitation, one or more of handles, hack straps, or shoulder straps. The carrying elements, may be formed from nylon webbing, fabric, leather, simulated leather, or the like.

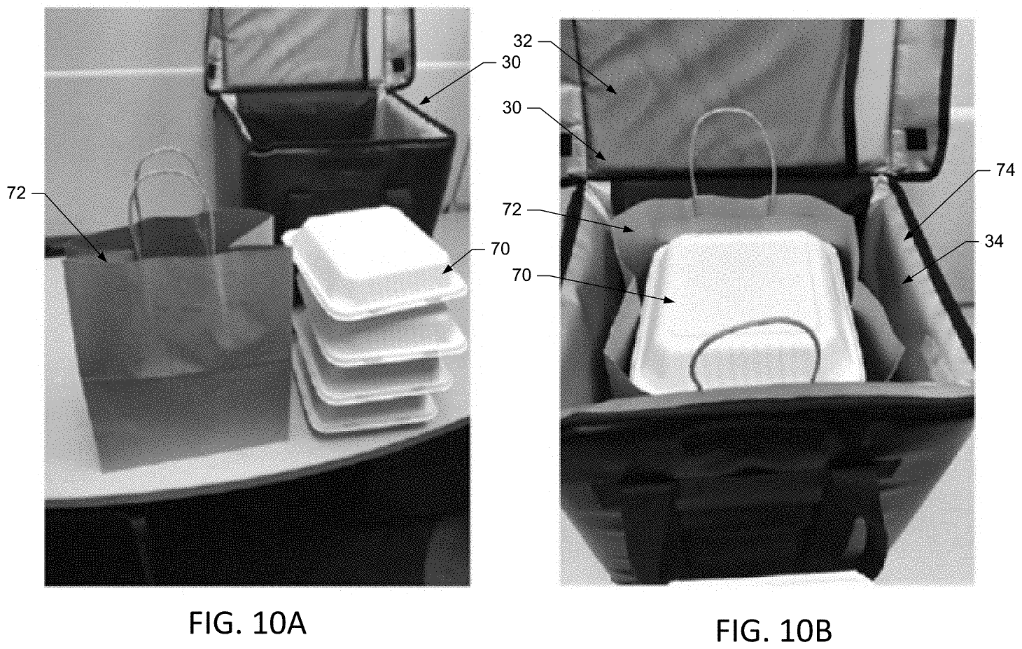

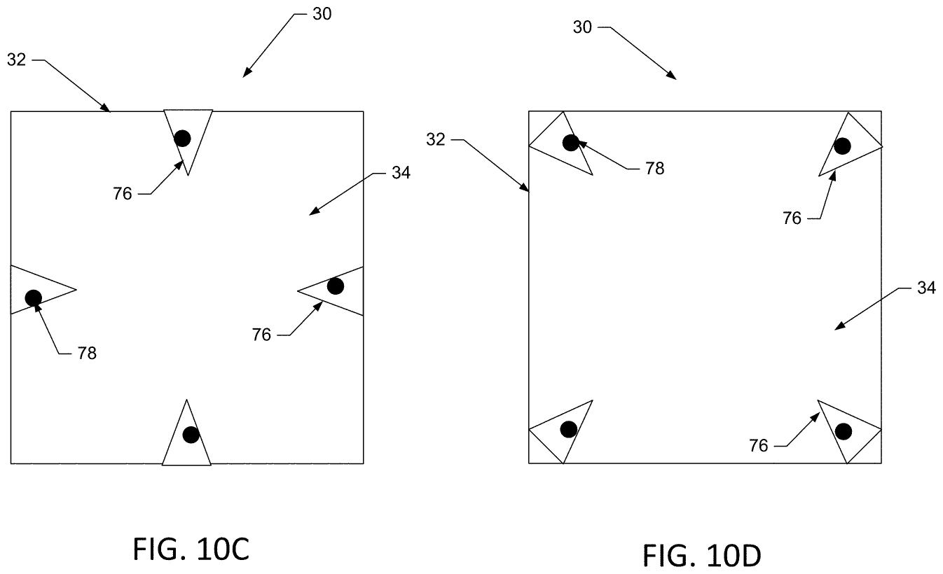

The interior of the insulated walls 12, e.g. within the food chamber, may include an internal covering (an example interior is shown in FIG. 10B). The internal covering may be a nylon covering, PVC covering, or other suitable material. The nylon covering may be water resistant and allow steam or moisture to escape the food chamber, reducing the moisture and humidity within the food chamber. The PVC covering may be resistant to moisture absorption, enabling a leak proof food chamber that may be easily cleaned and sanitized. In some example embodiments, the internal covering may form a removable liner that may be removed and replaced for cleaning or in the event of damage.

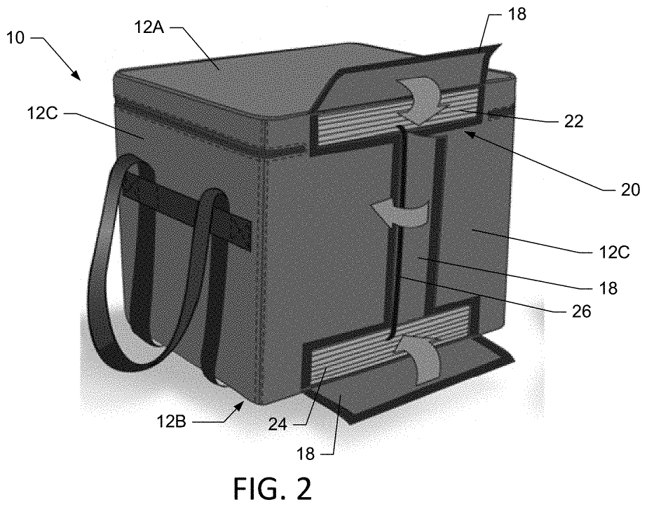

FIG. 2 illustrates an example food delivery container including a climate control system 20 and maintenance access flaps 18 according to some example embodiments. As discussed in further detail below, the IFC 10 may include a climate control system 20. The climate control system 20 may include a climate control portion 22 and a power portion 24. The climate control portion 22 may include one or more heating elements (and/or cooling elements) and a fan configured to circulate heated (and/or cooled) air within the food chamber. The power portion 24 may be configured to supply electrical power to the climate control portion 22, such as through a power cable 26. In an example embodiment, the climate control system 20 is disposed within the insulated walls 12 of the IFC 10. In the depicted example, the climate control portion 22 is disposed within the top wall 12A and the power portion 24 is disposed in the bottom wall 12B. The depicted example is merely for illustrative purposes and one of ordinary skill in the art would immediately appreciate that the climate control unit 20 may be disposed in any of the insulated walls 12. Further, the climate control portion 22 and power portion 24 may be disposed separately, e.g. in different insulated walls 12, as depicted, or in the same insulated wall 12. Additionally, although depicted separately, the climate control portion 22 and the power portion 24 may be housed in a common enclosure.

In some example embodiments, the IFC 10 may include one or more maintenance accesses 18, such as maintenance flaps. The maintenance accesses 18 may be configured to enable access to the climate control system 20 for maintenance, replacement, and/or inspection. The maintenance accesses 18 may include a closure, such as one or more of a hook-and-loop closure, a zipper closure, a slide release buckle closure, or the like.

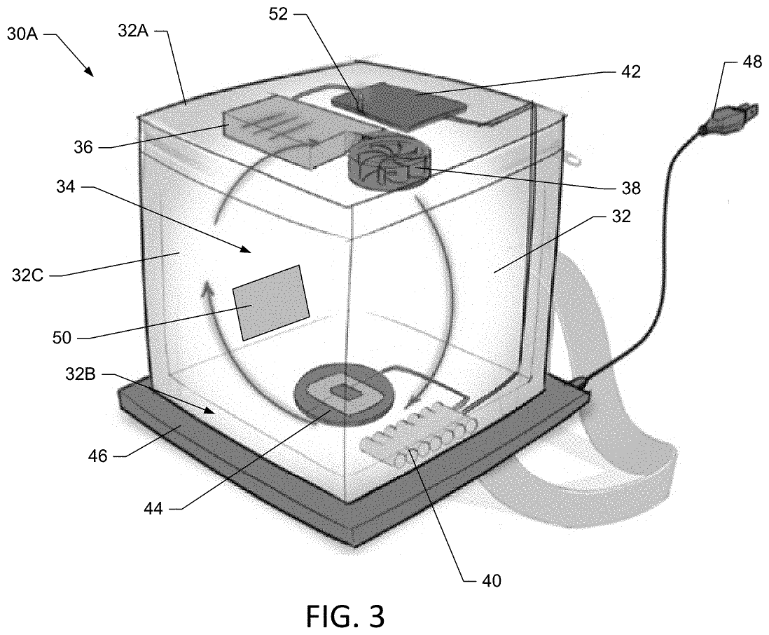

FIGS. 3-5 illustrates example food delivery containers including climate control systems according to some example embodiments.

FIG. 3 depicts an IFC 30A similar to the IFC 10 discussed above in reference to FIGS. 1 and 2, including insulated walls 32 (e.g., top wall 32A, bottom wall 32B, and side walls 32C) forming a food chamber 34.

The IFC 30A includes a climate control system having a temperature control element or “temperature element.” The temperature element may be a heating element, such as a resistive heating coil or other suitable heat source, a cooling element, such as a refrigeration unit or other suitable cooling source, or may be configured to provide both heating and cooling, such as a thermoelectric generator (TEG), such as a Peltier plate. The TEG may be configured to provide heat when current is applied to the TEG in a first direction and provide cooling when current is applied in a second direction. More particularly, a first side of the TEG may be configured to provide heating or cooling for the climate control system and a second side of the TEG may be configured as a heat or cooling sink. The examples provided below include a heating element for illustrative purposes. One of ordinary skill in the art, however, would immediately appreciate that the same thermodynamic principals described in the context of heating the food chamber apply equally to cooling the food chamber 34.

In some example embodiments, the IFC 30A includes a heating element 36 and a fan 38. In the depicted embodiment, the heating element 36 and fan 38 are disposed in a top wall 32A, and a power supply 40 (discussed below) is disposed in a bottom wall 32B. The fan 38 may circulate air within the food delivery container such as through the climate control system into the food chamber 34. The fan 38 may be an axial flow fan, a centrifugal fan (e.g. blower), or a cross-flow fan, among other fan types.

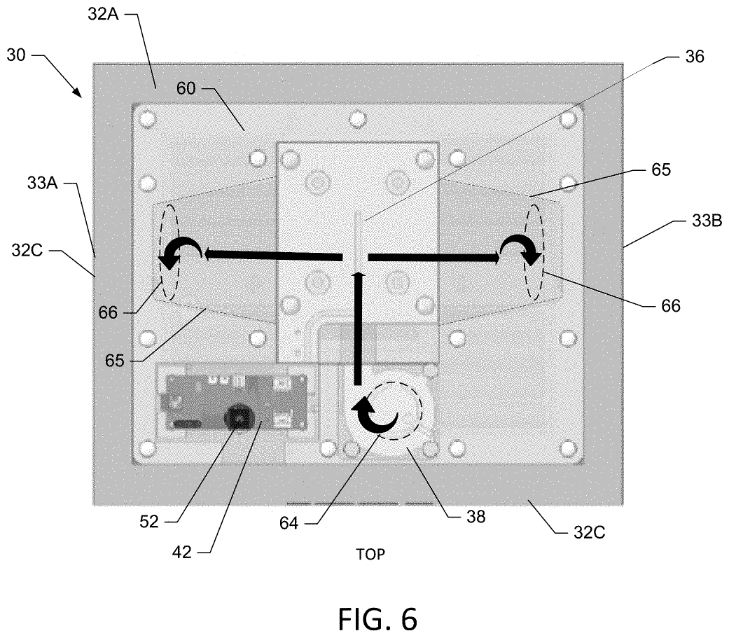

In some example embodiments, discussed below in reference to FIGS. 6-8, the climate control system may include an air flow pathway, and the heating element 36 may be disposed within the air flow pathway. The fan 38 may be in air flow communication with the food chamber 34 through an inlet opening and an outlet opening in one of the insulated walls 32. The fan 38 may be configured to draw in air from the food chamber through the inlet opening and push air into the food chamber through the outlet opening, such that air travels through the air flow pathway and over the heating element 36 to circulate heated air within the IFC 30A, particularly within the food chamber 34. The circulating heated air applies convection heat to the food chamber 34.

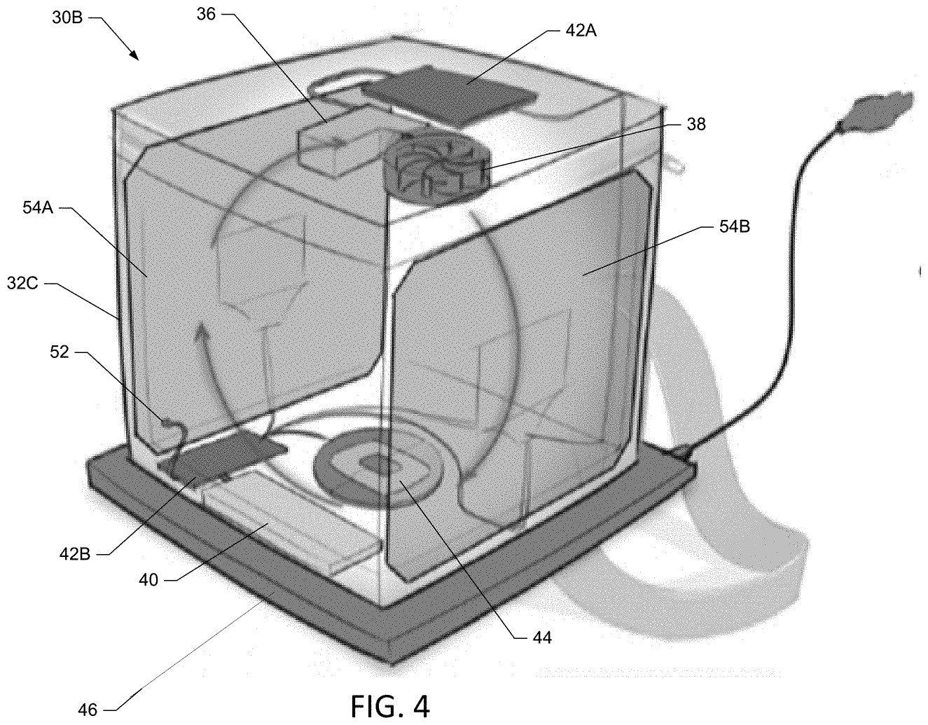

The IFC 30A may include a power supply 40 configured to supply electrical power to the fan 38 and/or the heating element 36. The power supply may be a replaceable power source, such as alkaline batteries, or a rechargeable power source, such as lithium batteries or one or more capacitors, such as super capacitors. The rechargeable power source may include cylindrical batteries (e.g., depicted in FIG. 3) and/or capacitors and/or flat pack, e.g. credit card, batteries or capacitors (e.g., depicted in FIG. 4). Additionally or alternatively, the power supply may include a wired power supply, such as a DC vehicle plug or an AC wall plug, configured to receive AC or DC power from a power source to power the climate control system and/or recharge the rechargeable power source.

In some example embodiments in which the IFC 30A includes a rechargeable power supply 40, the IFC 30A may include a wireless charging element 44 configured to receive an inductive charge and charge the rechargeable power supply 40. In some example embodiments, the wireless charging element 44 may include an inductive charging coil configured to be placed in proximity to an inductive charging pad 46. The inductive charging pad 46 may include one or more inductive charging coils powered by a wired power supply 48. The wired power supply 48 may be configured to receive AC or DC power from a power source, such as a vehicle DC power socket or an AC wall socket. The inductive charging pad 46 may generate a magnetic field that induces a voltage in the inductive charging coil that may be utilized to charge the rechargeable power supply 40. In use, the inductive charging pad 46 may be placed on a car seat or trunk to charge the IFC 30A when the IFC 30A is in transit to deliver food products. Additionally or alternatively, the inductive charging coil 46 may be placed on a counter, shelf, or storage area to charge the IFC 30A when the IFC 30A is not in use, being loaded with food products, or being pre-heated, as discussed herein.

In some example embodiments, IFC 30A may control the electrical power supplied to at least one of the fan 38 or heating element 36 to maintain the temperature of the food chamber 34 at a predetermined temperature or within a predetermined temperature band. For example, the IFC 30A may include one or more temperature switches configured to open at a first temperature at a high end of the temperature band, such as 200 degrees and close at a second temperature at a low end of the temperature hand, such as 150 degrees. In an example in which the food chamber 34 is cooled, the temperature switches may have an upper temperature at 30 degrees or 50 degrees and a lower temperature at 0 degrees or 35 degrees, for frozen or chilled food products, respectively. In some embodiments, the IFC 30A may utilize the one or more temperature switches for safety, e.g. the high temperature switch may be configured to de-energize the heating element to prevent damage to the IFC 30A.

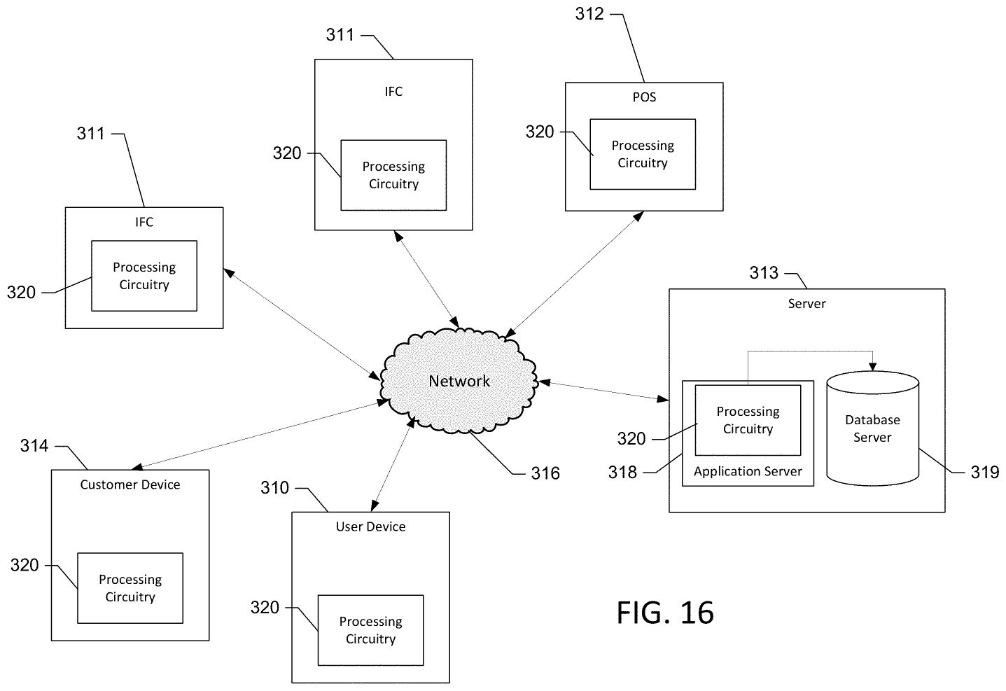

In some example embodiments, the IFC 30A may include processing circuitry 42, such as discussed in FIG. 16 in reference to processing circuitry 320. The processing circuitry 42 may include or be in communication with one or more temperature sensors configured to measure the temperature of the food chamber 34. The processing circuitry 42 may be configured to control the electrical power supplied to at least one of the fan 38 or heating element 36 to maintain the temperature of the food chamber 34 at predetermined temperature or within a predetermined temperature band.

In some example embodiments, the IFC 30A may include a user interface 52 in communication with the processing circuitry 42. The user interface may include one or more indicators, such as light emitting diodes (LEDs), a display, such as a liquid crystal display (LCD), a speaker, a buzzer, or the like. The user interface, in combination with the processing circuitry 42, may generate user information, such as a beacon identifying a specific IFC from a plurality of IFCs, a charging status, a heating status, or other user information. The user interface 52 may be disposed on a top wall 32A (depicted in FIG. 3), on a side wall 32C (depicted in FIG. 4), or any other suitable location.

In some example embodiments, the IFC 30A includes a humidity control element 50 configured to remove or add humidity to a volume of air within the food chamber 34 to maintain a predetermined humidity level or humidity band. The humidity control element 50 may include an absorbent fabric, desiccant, rechargeable desiccant, mixed salts, or the like. In some example embodiments, the humidity control element 50 includes a flow valve configured to limit air flow across the humidity control element when the flow valve is in a shut position. The IFC 30A may include a humidity sensor configured to measure the humidity of the volume of air within the food chamber 34. In some example embodiments, the processing circuitry 42 may receive humidity data from the humidity sensor and compare the humidity data to one or more humidity thresholds. In response to the comparison of the humidity data to the one or more humidity thresholds, the processing circuitry 42 may cause the flow valve to be opened when the humidity data exceeds the one or more humidity thresholds or be closed when the humidity data does not exceed the one or more humidity thresholds.

FIG. 4 depicts another example IFC 30B in a second configuration. The IFC 30B may include a first silicone heating pad 54A and a second silicone heating pad 54B. The silicone heating pads 54A, 54B may be disposed on the interior surface of the insulted walls 32, such as side walls 32B as shown. In some example embodiments, the first silicone heating pad 54A is disposed proximate to a first insulated wall 32C and the silicone second heating pad 54B is disposed proximate to a second insulated wall 32C opposite the first insulated wall.

In some example embodiments, the silicone heating pads 54 may be positioned within the food chamber 34 aligned with the one or more air passage outlets from the climate control system. In such a configuration, the silicone heating pads may add heat to the flowing air as the air flows past the silicone heat pads, e.g. adding to the convection within the food chamber 34. Additionally or alternatively, the silicone heat pads 54 may be positioned on side walls 32C not aligned with the one or more air passage outlet openings of the climate control system. In such a configuration, the silicone heat pads may radiate heat into the food chamber 34, e.g. adding conductive heat.

The IFC 30B may include a distributed processing circuitry including first processing circuitry 42A and second processing circuitry 42B. The first processing circuitry 42A may be configured to control the heating element 36 and fan 38. The second processing circuitry 42B may be configured to control, the user interface 52, the silicone heating pads 54, and/or charging of the power supply 40 from the wireless charging element 44.

In some example embodiments, the climate control system may also add conductive heat to the food chamber 34. As discussed in further detail below in reference to FIGS. 6-8, the radiative heat of the heating element 36 may be captured by one or more heat distribution elements that may reduce localized temperature peaking and apply conductive heat to the food chamber 34. Similarly, heat generated by the power supply 40 may also be captured by the one or more heat distribution elements.

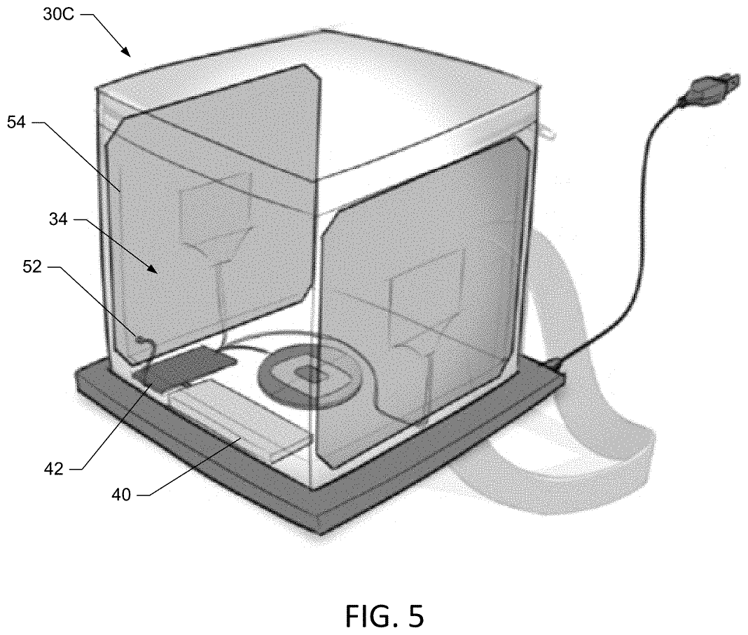

FIG. 5 depicts a further example embodiment of an IFC 30C. In the depicted configuration, the IFC 30C does not include a fan. Instead, the food chamber 34 is heated by one or more silicone heating pads 54. The IFC 30C includes a power supply 40, wireless charging element 44, a user interface 52, and processing circuitry 42 similar to the respective elements discussed above in FIGS. 3 and 4.

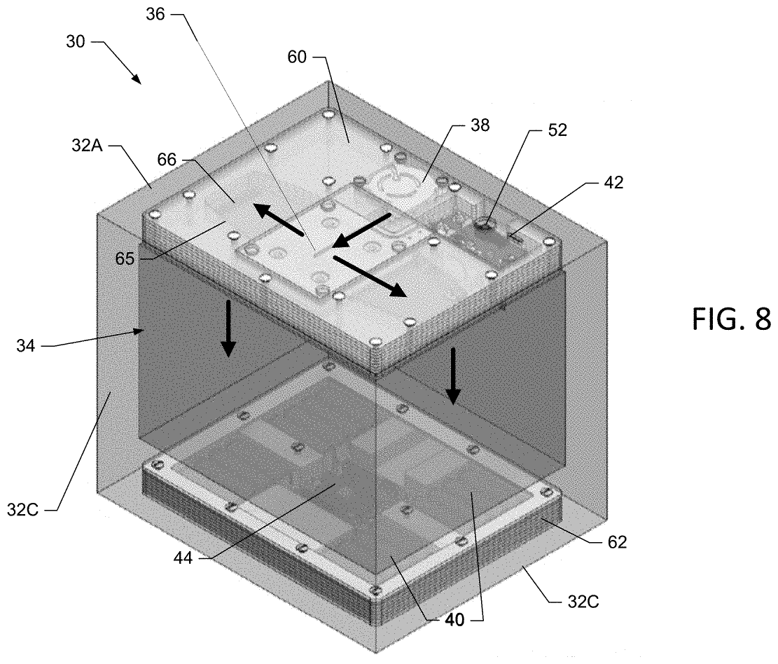

FIG. 6 and FIG. 8 illustrate an example top transparent view and a perspective transparent view of an IFC 30, respectively, in a configuration similar to the IFC 30A discussed in reference to FIG. 3. The climate control system of IFC 30 may include the heating element 36. The heating element 36 may be a resistive coil encased in one or more baffle plates. The baffle plates may, in some embodiments, create a tortuous pathway for air to travel through or past the heating element 36 to thereby increase heat transfer to the air. In some embodiments, the heating element 36 itself may include one or more air inlets and one or more air outlets. The climate control system of IFC 30 also includes a fan 38. The fan 38 may be configured to draw in air from the food chamber 34, such as through an inlet opening 64 (shown in FIG. 6). The air exiting the fan 38 may be discharged into or past the heating element 36 and discharge thereafter. The air may then pass through one or more air flow outlets 66 and into the food chamber 34. In some example embodiments, the IFC 30 may include baffling, tubing, molding, or the like configured to create an air flow pathway from the inlet opening 64 to the outlet opening(s) 66. In some example embodiments, the baffling is provided by a heat distribution element 60. The heating element 36 and/or the fan 38 may be disposed within the air flow pathway, as discussed below. Along these lines, while shown with the heating element 36 being positioned downstream of the fan 38, the climate control system may be arranged with the heating element 36 being positioned upstream of the fan 38 such that the fan pulls air past the heating element.

In some example embodiments, the IFC 30 includes a heat distribution element 60 disposed in the top wall 32A. The heat distribution element 60 may comprise a plurality of metal plates, or other suitable heat conducting materials. The heat distribution element 60 may be configured to conduct heat radiated by the heating element 36 and/or fan motor (not shown) across the heat distribution element 60. In some embodiments, the conduction of heat may add conductive heating to the IFC 30, thereby reducing the electrical power consumption required to operate the IFC, e.g. recapturing lost radiative heat. Additionally, the heat distribution element 60 may reduce or prevent localization of heat, which may prevent damage to the IFC 30 and/or increase the effective life of the IFC 30, as well as, in some cases, avoid non-uniform heating within the food chamber.

In addition to the heat transfer benefits, the heat distribution element 60 may also include a void or cut out 65 in one or more of the metal plates to create an air flow pathway (e.g., the above described air flow pathway). In some example embodiments, a top and bottom metal plate of the heat distribution element 60 may be substantially solid. One or more internal plates may include cutouts 65 to create a continuous air pathway between the inlet opening 64 and the one or more outlet openings 66. The fan 38 and/or heating element 36 may be disposed within the air flow pathway formed by the cutouts 65.

As depicted by the arrows in FIG. 6 and FIG. 8, air from the food chamber 34 is drawn in through an inlet opening 64 into the air flow pathway, such as by the fan 38. In the depicted embodiment, the fan 38 is a centrifugal fan having a central inlet opening facing the inlet opening 64. Spinning of the fan 38 generates a low pressure area that draws air through the inlet opening 64 and a high pressure area about a periphery of the fan 38. A fan outlet is disposed in a peripheral wall of the fan 38 to discharge high pressure air. The fan outlet is disposed proximate to the inlet of the heating element 36. As the air passes through the heating element 36 the air is heated and discharged through outlets disposed on either side of the heating element 36. As discussed above, the heating element 36 may include one or more internal baffles configured to lengthen the air path through the heating element 36 to increase the heat transfer to the air passing therethrough. The cutout 65 in the metal plates of the heat distribution element 60 may form an air duct extending from the outlets on each side of the heat element 36 to the outlet openings 66 disposed proximate to opposing side walls 32C at opposite edges 33A, 33B of top wall 32A. The heated air flows through the air duct and through the outlet openings 66 to the food chamber 34, thereby circulating heated air within the food chamber 34. Adding in the circulating of the heated air, the inlet opening 64 is disposed remote from the outlets opening 66. Particularly, the inlet opening 64 is disposed proximate to a side wall 32 different from either of the outlet openings 66. Additionally, the inlet opening 64 is disposed approximately equidistant from each of the outlet openings 66.

In some example embodiments, the heat distribution element 60 may also include cutouts for the processing circuitry 42 and be configured to conduct heat generated by the processing circuitry 42, such as by a processor. In some example embodiments, a cutout in the top plate of the heat distribution element 60 and/or the top wall 32A of the IFC 30 may be included for access to the user interface 52. In this depicted embodiment, the user interface includes an LED.

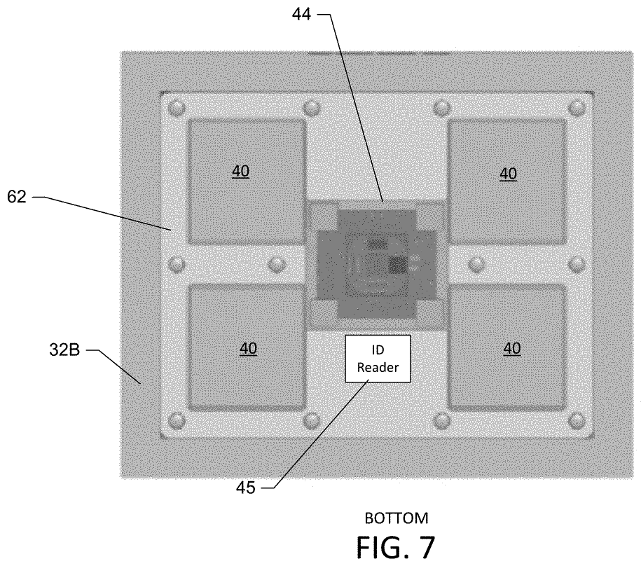

FIG. 7 illustrates an example bottom partially transparent view of the IFC 30 according to some example embodiments. As depicted in FIG. 7, and referring to FIG. 8, a power portion of the climate control system of the IFC 30 may be disposed in the bottom wall 32B. The positioning of the climate control portion of the climate control system in the top wall 32A and the power portion in the bottom wall 32B may provide balance to the IFC 30, preventing the IFC 30 from being top heavy or bottom heavy. The power portion of the climate control system may include one or more power supplies 40 and a wireless charging element 44, configured to provide electrical power to the climate control portion of climate control system.

In the depicted example, the power supplies comprise four cylindrical power supplies disposed at the corners of bottom wall 32B. The power supplies 40 may be rechargeable batteries, capacitors, or the like. The power supplies 40 may be relatively heavy and, thus, distribution of the power supplies 40 about the bottom wall 32 may allow the IFC 30 to have a more balanced weight distribution.

The wireless charging element 44 includes an inductive charging coil configured to receive an induced voltage from an inductive charging pad and provide electrical power to the power supplies to recharge the batteries and/or capacitors. In the depicted embodiment, the inductive charging coil is disposed at a relatively central location in the bottom wall between the power supplies 40. The central location (and positioning in the bottom wall) may increase the likelihood of the inductive coil being within the magnetic field of an inductive charging pad, when placed thereon, and reduce wiring harness lengths to each of the power supplies 40.

In some example embodiments, a second heat distribution element 62 is disposed in the bottom wall 32B. Similar to the heat distribution element 60 discussed above in reference to FIG. 6, the second heat distribution element 62 may be formed from one or more metal plates or other suitable heat conductive materials. The second heat distribution element 62 may be disposed proximate to the one or more power supplies 40 and/or wireless charging element 44. For example, one or more of the metal plates of the second heat distribution elements may have cutouts disposed therein configured to receive the power supplies 40. The second heat distribution element 62 may be configured to conduct radiative heat from the power supplies 40. The conduction of heat by the second heat distribution elements 62 may reduce localized heat caused by the power supplies limiting or preventing damage and extending the effective life of the IFC 30 and preventing non-uniform heating of the food products within the food chamber. Additionally, the conduction of heat may add conductive heating to the IFC 30 to reduce the electrical power consumption required to operate the IFC 30, e.g. recapturing radiative heat from the power supplies reducing the heat load on the heating element 36.

In some example embodiments, the IFC 30 may include an identifier reader 45, such as a barcode reader, character reader, quick response (QR) code reader, or RFID reader. The identifier reader 45 may be disposed in an insulated wall 32, such as the top wall 32A or the bottom wall 32B, in a location suitable for reading an identifier associated with one or more food packages when the food packages are placed into the food chamber 34. The identifier reader 45 may provide identification data to the processing circuitry 42 to determine an order status, a target temperature or temperature band, or the like. In this regard, in some embodiments, the order status can be confirmed prior to delivery, such as enabling a remote operator to confirm completion of the order. Additionally or alternatively, the identifier reader 45 may write information to the identifier. For example, the identifier reader 45 may write the time the food package 70 was placed into the food chamber 34, the temperature of the food chamber at one or more times, the target temperature or target temperature band, or the like.

### Example Food Packages and Food Package Supports

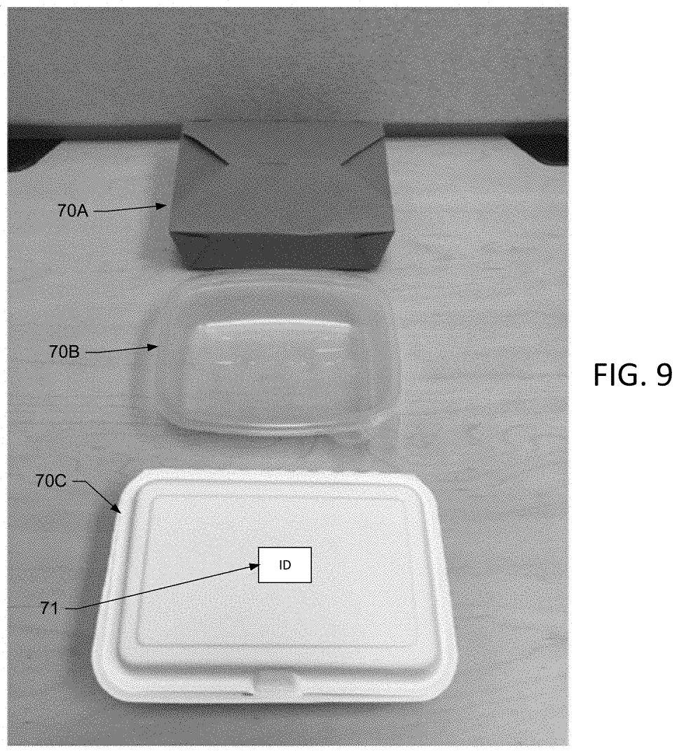

FIG. 9 illustrates example food packages according to some example embodiments. The food industry includes various types of food packages. The food packages may be configured for the type of food being delivered, the heat of the food, moisture content of the food, or the like. Some typical food packages intended for use with various example food delivery containers may include a folded food package 70A, a sealed lid food package 70B, a clam shell food package 70C, or the like. The food packages may be formed from a variety of materials including paper board, molded pulp, foam, plastic, biodegradable composite materials (e.g. sugarcane or corn starch), aluminum, or the like. In some examples, the food packages may be reusable, e.g. the food packages may be returned to the food provider, washed, and used to deliver food again.

In some example embodiments, the food packages 70 may include an identifier 71. The identifier may be printed or embedded into the food package 70 or may be printed or embedded in a label placed on the food package 70. The identifier 71 may include data corresponding to a target temperature or target temperature band, the food product contained therein, the time prepared, an order number, or the like. The identifier may include one or more characters (e.g. numbers, letters, symbols, or the like), a barcode, a quick response (QR) code, a radio frequency identifier (RFID), or the like. The identifier 71 may be read by the identifier reader 45 associated with the IFC 30 to determine an order status, such as, all ordered food products are placed into the food chamber 34. Additionally or alternatively, the identifier 71 may be written to by the identifier reader 45. For example, the identifier reader 45 may write the time the food package 70 was placed into the food chamber 34, the temperature of the food chamber at one or more times, the target temperature or target temperature band, or the like.

FIGS. 10A and 10B illustrate an example of loading food packages into an IFC 30 according to some example embodiments. In some example embodiments, food packages 70 may be vertically stacked and placed into a bag 72, such as by order or delivery location. In some example embodiments, order information may be placed on the bag, food packages, or on the IFC 30. For example, the IFC 30 may include a plastic transparent window on an exterior surface of an insulated wall 32. The window may be configured for order information to be placed within the window for quick reference by a user, such as a delivery person.

At least one of the insulated walls 32, such as the top wall 32A, may be movable between a closed position and an open position to enable food packages to be placed within or removed from the food chamber 34. The insulated wall 32 may be moved to the open position and the bag 72 may be placed within the food chamber 34 of the IFC 30. The insulated wall 32 may then be placed in the closed position and sealed.

FIGS. 10C and 10D illustrate example food chambers 34 including wall protrusions 76 extending from an insulated wall 32 into the food chamber 34. One or more wall protrusions 76 may be disposed on one or more of the insulated walls 32 (or at corners between the walls). The wall protrusions may be configured to enable complementary food packaging to be placed into the food chamber and limit or prevent non-complementary food packaging from being placed into the food chamber. For example, food packages 70 may include a complementary recess in one or more edges of the food package 70, such that when placed into the food chamber, the one or more wall protrusions align with the one or more complementary recesses. Further, food packages 70 not having complementary recesses may be prevented or limited from being placed into the food chamber.

Additionally or alternatively, the wall projections 76 may be configured to channel heated or cooled air through the respective one or more wall projections. In an example embodiment, the wall projections 76 may be aligned with the inlet opening 64 and/or the outlet openings 66 of the IFC 30 to aid in circulating of the heated or cooled air, such as from the top wall 32A throughout the food chamber 34. In some example embodiments, the wall projections 76 may also include one or more flow holes 78 configured to enable air flow from the wall projection into the food chamber. The flow holes may be disposed at opposing ends of the wall projections 76, at intervals along the wall projections 76, or at any other suitable location to enable a desired air circulation.

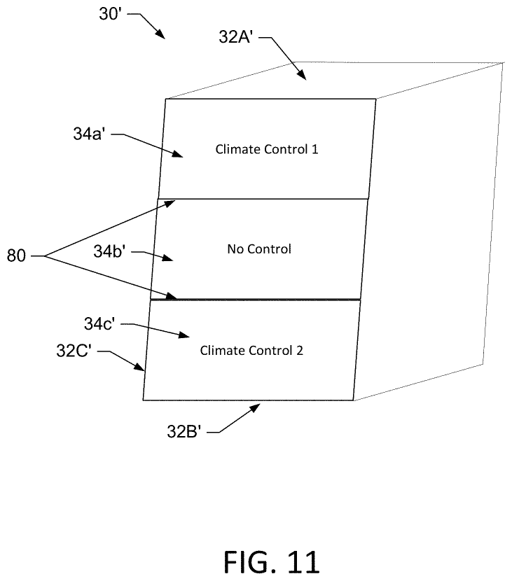

FIG. 11 illustrates an example partitioned IFC 30′ according to some example embodiments. The partitioned IFC 30′ may include a plurality of food chambers 34a′, 34b′, 34c′ that may be formed in the IFC 30′, such as by segmenting a food chamber using partition walls 80. The partition walls 80 may be insulated walls, similar to insulated walls 32. Additionally or alternatively, the partitions may include fabric, plastic, metal, or the like.

In some example embodiments, the IFC 30′ may have a side wall 32C′ (not shown) that moves between a closed position and open position to allow access to the plurality of food chambers 34′. In some example embodiments, one or more of the food chambers 34a′, 34b′, 34c′ may be climate controlled. In some example embodiments, some or all of the food chambers may be climate controlled by a common climate control system. Alternatively, in some example embodiments, different climate control systems may be used for each food chamber. For example, a first food chamber 34a′ may be climate controlled by a first climate control system and a second food chamber 34b′ may be climate controlled by a second climate control system. In some example embodiments, the IFC 30′ may include both climate controlled and non-climate controlled food chambers. In the depicted embodiment, the IFC 30′ includes a first food chamber 34a′ climate controlled by a first climate control system, a second food chamber 34b′ that is not climate controlled, and a third food chamber 34c′ that is climate controlled by a second climate control system.

In some example embodiments, the first food chamber 34a′ may be climate controlled to maintain a target temperature of 150-160 degrees, for heated food products. The third food chamber 34c′ may be climate controlled to maintain a second target temperature band of 40-50 degrees, for chilled food products. In such an embodiment, a single IFC 30′ may be deployed for a food order, such as pizza, soda, and salad, and maintain suitable temperatures for both heated and chilled food products.

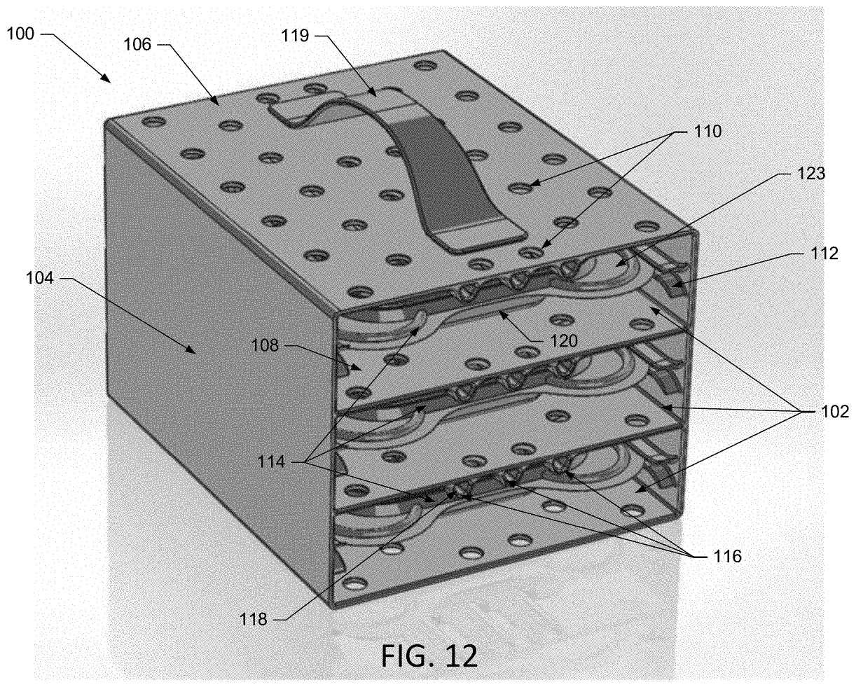

FIG. 12 illustrates a perspective view of an example food package support 100 including example food packages 120 according to some example embodiments. In some embodiments, the food package support 100 may be configured to cooperate with the IFC 30 to maximize air circulation within a food chamber 34. The food package support 100 may be configured to be inserted into the food chamber 34 of an IFC 30. As discussed below, air flow holes 110 disposed in the food package support 100 may enable the heated/cooled air to circulate between food packages 114 placed in the food chamber 34.

The food package support 100 may include a plurality of food package receptacles 102 defined by a plurality of receptacle walls. The plurality of receptacle walls may include common side walls 104 disposed on opposite sides of the food package support 100. The plurality of receptacle walls may also include an upper wall 106 and lower wall 108 for each of the plurality of food package receptacles 102. In some example embodiments, the food package support 100 may include a rear wall (not shown). The upper walls 106 and lower walls 108 of the plurality of food package receptacles 120 may include flow holes 110 enabling air flow through the food chamber 34. In some example embodiments, one or more of the flow holes 110 may be configured to be aligned with the inlet opening 64 and/or the outlet openings 66 of the climate control system. In an example embodiment, the food package support 100 may include one or more handles 119 to facilitate insertion and removal of the food package support 100 from the IFC 30.

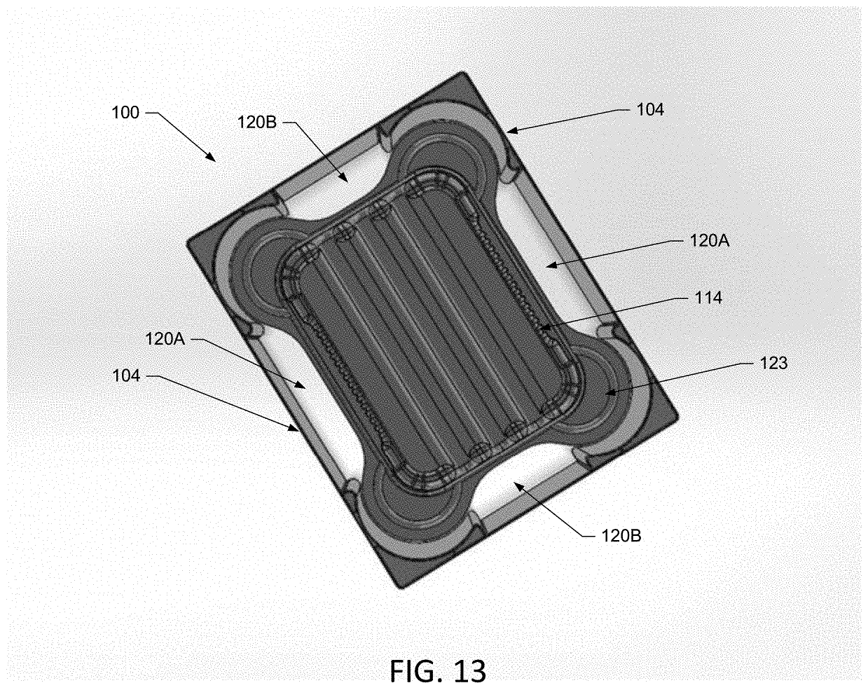

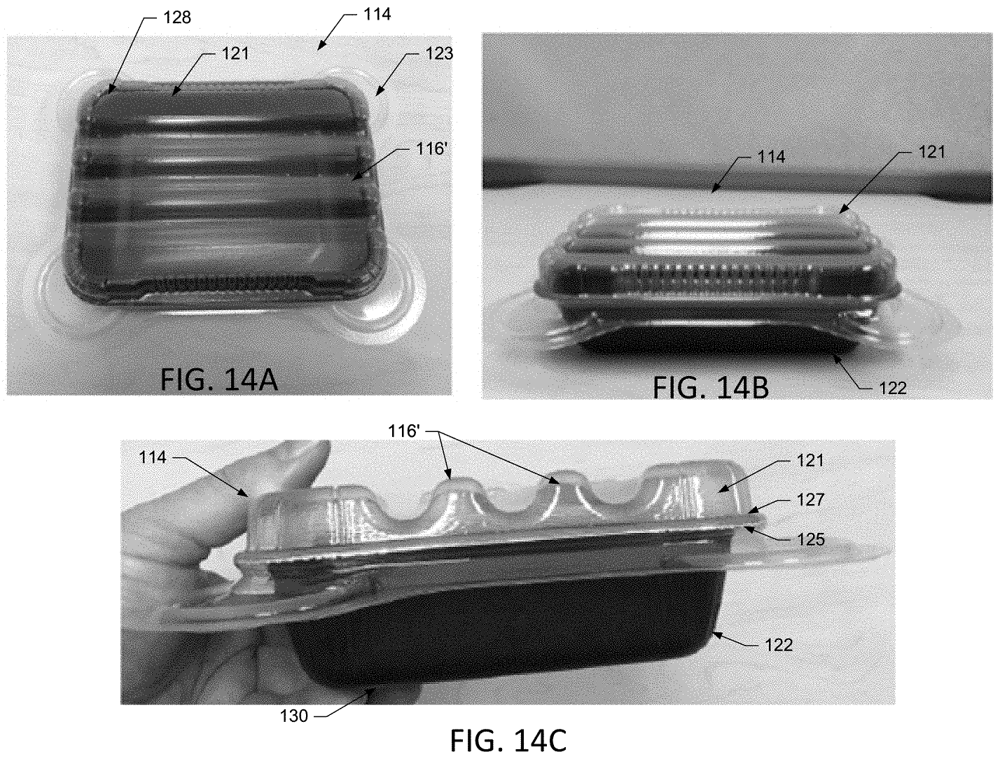

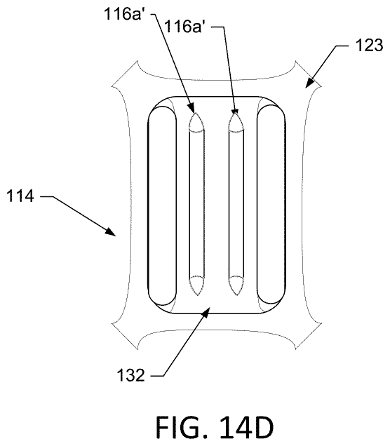

Referring briefly to FIGS. 13-14D, the food packages 114 may also be configured to maximize heated/cooled air circulation within the food chamber 34. Particularly, the food packages 114 may have one or more concave edges 120A, 120B. For example, the food package 114 may include two or more projections 123 extending from a lid 121 or food receiving portion 122 defining the concave edges 120. In the example depicted in FIG. 12, the food package includes a first set of concave edges 120A disposed on a long side of the food package 114 and a second set of concave edges 120B disposed on a short side of the food package 114. In an example embodiment, one or more of the concave edges 120 may be aligned with the flow holes 110 and/or the inlet opening 64 or an outlet opening 66.

Turning back to FIG. 12, the food package support 100 may include a plurality of pinch slots 112 disposed on the common side walls 114 in each of the plurality of food package receptacles 102. The pinch slots 112 may be configured to engage a surface of a food package 114, such as the projections 123 to limit opening of the food package 114 when inserted into the food package receptacle 102. The pinch slots 112 may include a tapered open end configured to guide the food packages projections 123 into the pinch slots 112.

In some example embodiments, the upper wall 106 or the lower wall 108 of each of the food package receptacles 102 may include one or more ribs 116 configured to engage a complimentary one or more ribs 116′ (FIGS. 14A and 14D) disposed on a bottom 122 or top 121 of a food package 114. In the embodiment depicted in FIG. 14D, the ribs 116a′ may include a taper that enables easier insertion into the food package receptacle 102. The interaction of the ribs 116, 116′ may prevent lateral movement of the food package 114. Additionally, the ribs 116 may include rib flow holes 118 enabling heated/cooled air to flow through the one or more ribs 116. The rib flow holes 118 may be disposed at a first end and second end of the ribs 116, or may be disposed at any other suitable location.

Turning to FIGS. 14A-14D, the food package 114 may include a food receiving portion 122 including a first mating surface 125 about a periphery of the lower receiving portion 122. The food package 114 may also include the lid 121 including a complementary mating surface 127 configured to seal the food package 114 when engaged with the mating surface 125 of the food receiving portion 122.

The lid 121 may include ribs 116′ configured to enable heated/cooled air to flow between vertically stacked food packages 114. Additionally, the ribs 116′ may be configured to accept the complementary ribs 116 of the food package support 100, as discussed above. In an example embodiment, depicted in FIG. 14D, the ribs 116a′ may be recessed from the ends of the food package 114 forming an air funnel 132. The air funnel 132 may cause a mass flow rate of the air to increase as the air moves across the lid 121 through the ribs 116a′, thereby increasing heat transfer.

In some example embodiment, the food package 114 may include a recess or projection 130 disposed on the food receiving portion 122 configured to engage a complementary projection or recess 128 in the lid 121. The recesses and projections 128, 130 of the lid 121 and food receiving portion 122 may limit lateral movement between stacked food packages, preventing or limiting sliding of food packages on one another. In some example embodiments, the recesses and projections 128, 130 of the lid 121 and food receiving portion 122 may interlock or clip together to form a unified food package from a plurality of food packages 114.

### Example User Interfaces and Controls

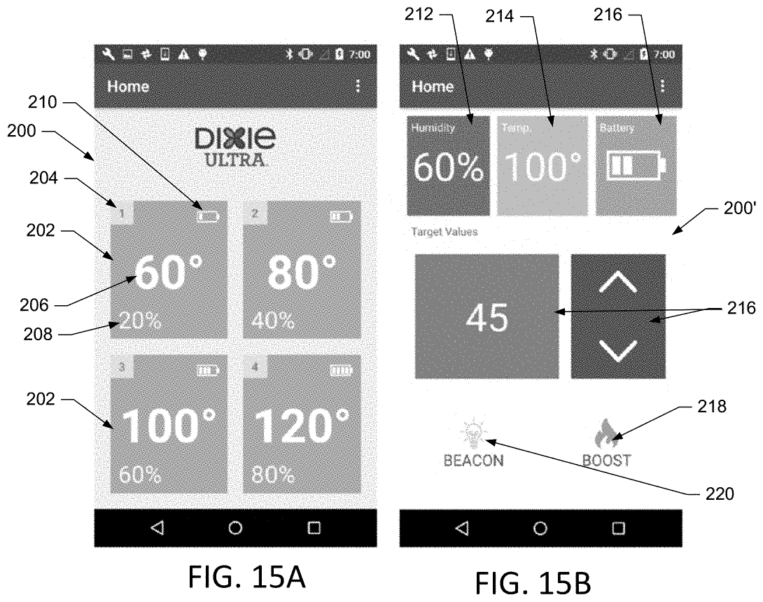

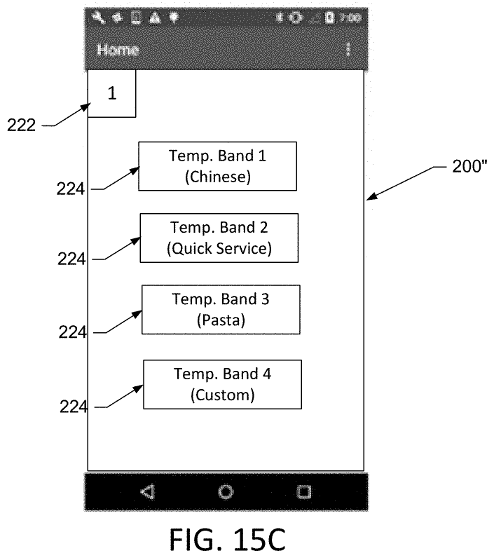

FIGS. 15A-15C illustrate example user interfaces (such as through software applications) for control of an IFC 30 according to some example embodiments. A user interface may be provided for control of one or more IFCs at any, some, or all of an IFC, a mobile computing device (e.g. a smart phone, computing tablet, or the like), a computer terminal, a POS device, or the like. The examples below are generally discussed in the context of the user interface disposed at a remote computing device for explanatory purposes. Additionally, control functions are generally discussed as emanating from the remote computing device for explanatory purposes, however these control functions may be performed locally at the IFC 30, at a computing device, at a POS device, or a combination thereof.

As depicted in FIG. 15A, a computing device may receive status data regarding a plurality of IFCs 30. The status data may include one or more of temperature data, humidity data, battery status data, delivery status, lid position, selected temperature or temperature band, or the like. A user interface 200 may include a plurality of IFC data icons 202. Each of the data icons may include an IFC identifier 204, such as a number, letter, character, shape color, or the like. The IFC data icons 202 may display at least a portion of the status data. For example, in the depicted example, the IFC data icons 202 include a current temperature 206, a current humidity 208, and a current power supply status 210 for the respective IFC.

In some example embodiments, an IFC control user interface 200′ may be provided, as depicted in FIG. 15B. A user may select an IFC data icon 202, causing the computing device to open an IFC control user interface 200′ for the respective IFC. The IFC control user interface 200′ may include some or all of the status data, including but not limited to, the current humidity 212, the current temperature 214, current battery status 216, or the like. Additionally, the IFC control user interface 200′ may include a manual temperature control 216. The manual temperature control may enable a user to enter a user input defining a target temperature and/or a target temperature band, such as 150 or 150-160 degrees, 45 or 40-50 degrees, 10 or 5-20 degrees or other suitable temperatures or temperature bands. In some example embodiments, a plurality of predefined temperature bands may be selectable in a temperature selection user interface 200″, as depicted in FIG. 15C. The temperature selection user interface 200″ may include a plurality of selectable temperature icons 224. The temperature icons 224 may indicate a temperature or temperature band value (e.g. 150-160 degrees, 5-20 degrees, 40-50 degrees, or the like), a food type (e.g. Chinese, quick service pasta, pizza, soda, ice cream, or the like) or other suitable indicator of temperature bands. The target temperature of temperature band may be transmitted to the IFC 30 for the processing circuitry 42 to execute. In some embodiments, the processing circuitry 42 may control the temperature of the food chamber 34 by controlling the electrical power supplied to at least one of the fan 38 or heating/cooling element to maintain the temperature of the food chamber at the target temperature or temperature band.

In some embodiments, the IFC control user interface 200′ may include a beacon function configured to generate a beacon request. The beacon request may be transmitted to the IFC 30 for the processing circuitry 42 to execute. The processing circuitry 42 may cause the user interface 52 to generate an audio or visual alert. The alert may assist the user in identifying a specified IFC 30 from a plurality of IFCs. The alert may include illumination of a light or LED, change in LED color, a chirp, or other suitable alert. In some embodiments, selection of the beacon icon 220 may enable or disable a beacon function, such as described herein.

In some example embodiments, the IFC control user interface 200′ may include a boost function 218. The boost function may enable a user to generate a boost request that is transmitted to the IFC 30. The processing circuitry 42 of the IFC 30 may cause control of the electrical power supplied to at least one of the fan 38 or heating/cooling element 36 to maintain the temperature of the food chamber 34 at a second temperature or in a second temperature band that is higher than the first target temperature or first target temperature band, such as 170-190 degrees. In some embodiments, selection of the boost icon 218 may enable or disable a boost function, such as described herein.

In some example embodiments, the IFC 30 may include a temperature sensor (or a plurality of temperature sensors) in communication with processing circuitry 42 of the IFC 30. The temperature sensor may be configured to measure the temperature of a food chamber 34 of the IFC 30. The processing circuitry 42 may receive temperature data from a temperature sensor. In some embodiments, the IFC 30 may transmit the temperature data to a remote computing device for display and/or control functions. The computing device may receive the temperature data and generate one or more control signals to control the electrical power supplied to at least one of the fan 38 or the heating/cooling element to maintain the temperature of the food chamber 34 in a first predetermined temperature or temperature band (e.g. a target temperature band), such as 150-160 degrees, or in a second predetermined temperature or temperature hand, such as 170-190 (e.g. a boost temperature band). The computing device may transmit the control signals to the IFC 30 for execution by processing circuitry 42. The processing circuitry 42 may control the temperature of the food chamber 34 by controlling the electrical power supplied to at least one of the fan 38 or heating/cooling element to maintain the temperature of the food chamber at the target temperature or temperature band or boost temperature or temperature band.

In some example embodiments, the IFC 30 may include a humidity sensor in communication with the processing circuitry 42. The humidity sensor may be configured to measure the humidity of the volume of air within the food chamber 34. In some embodiments, the IFC 30 may transmit the humidity data to a remote computing device for display and/or control functions.

In some example embodiments, the IFC 30 may include a humidity control element 50 configured to remove or add humidity to a volume of air within the food chamber 34 to maintain a predetermined humidity level or humidity band and/or a flow valve configured to limit air flow across the humidity control element when the flow valve is in a shut position. The computing device may receive the humidity data and compare the humidity data to one or more humidity bands or thresholds, such as 60%, 60-65%, or other suitable humidity level or band. The computing device may generate and transmit one or more control signals, e.g. a humidity control request, to the IFC to cause the flow valve to be opened when the humidity data exceeds the humidity threshold or be closed when the humidity data does not exceed the humidity threshold.

In some example embodiments, the IFC 30, vehicle associated with the IFC 30, or remote computing device associated with the IFC 30 may include a position sensor, such as a global positioning system (GPS) sensor. The computing device may be configured to determine a current location of the IFC 30 based on position data received from the position sensor. Using the current location, the computing device may be configured to automatically generate a boost request or beacon request based on a proximity to a delivery location. The computing device may determine a delivery location, such as via a user input defining the delivery location, via a user interface, or via ebbing received from a POS device. The computing device may compare the current location to the delivery location, and generate a boost request in response to the current location being within a predetermined boost threshold distance from the delivery location. The boost threshold distance may be a predetermined distance or estimated time to arrival sufficient to raise the temperature of the food product to an optimal (e.g., second) temperature. For example, the boost threshold distance may be 5 miles, 10 miles, 5 minutes, 10 minutes, or other suitable value. The computing device may cause the boost request to be transmitted to the IFC 30. The processing circuitry 42 of the IFC 30 may then cause control of the electrical power supplied to at least one of the fan 38 or heating/cooling element to maintain the temperature of the food chamber 34 at a boost temperature or within a boost temperature band that is higher than the first temperature or temperature band.

With regard to the beacon request, the computing device may compare the current location to the delivery location, and generate a beacon request in response to the current location being within a predetermined beacon threshold distance from the delivery location. The beacon threshold distance may be a predetermined distance from the delivery location indicative of arrival at the delivery location, such as 100 ft., 1000 ft., or other suitable distance. The beacon request may cause the IFC 30 to cause a user interface to generate an audio or visual alert. The alert may assist a user in identifying an IFC 30 associated with the delivery location (such as may be useful when more than one IFC is present). An advantage of such a mode is that it enables proper selection of the IFC for the delivery without having to open the IFC for visual confirmation (thereby effecting the temperature within the IFC). This also removes a possibility for mistaking the order through human error (e.g., forgetting which order is for which delivery location).

In some example embodiments, the computing device may utilize food product information to determine various factors for the IFC. For example, the computing device may determine a suitable IFC (from among various IFCs) for the selected food products, such as based on size, the determined target temperature band, and/or an estimated completion time for preparation of the food products. This information may be utilized to automatically determine an IFC and, in some embodiments, cause the IFC to pre-heat to the determined target temperature band, such as by an estimated completion time. Additionally, the computing device may cause the selected IFC to provide an audio or visual alert to identify itself to a food service operator to confirm proper IFC selection and/or that the IFC has completed the pre-heating/pre-cooling.

In some example embodiments, the computing device may receive user input defining a food product, such as though the user interface or from a POS device. The computing device may determine size, e.g. a total volume, of the delivery based on one or more defined food products. For example, the computing device may access a memory including a table having volume values for the food products, which may be summed to determine a total volume. Additionally or alternatively, the computing device may include a default volume for one or more food products which may be summered to determine the total volume of the delivery. The computing device may then determine an appropriate IFC based on the total delivery volume.

In some example embodiments, the computing device may determine a target temperature based on the food product(s). For example, the computing device may access a memory including a table having temperature values for the food products. Similarly, the computing device may determine one or more humidity thresholds based on the food products by accessing a table including humidity values for the respective food products. The computing device may cause the IFC to maintain a target temperature band based on the temperature values for the respective food products of the delivery. Additionally, the computing device may cause the IFC to maintain a target humidity level or humidity band based on the humidity values for the respective food products of the delivery.

In some example embodiments, the computing device may cause a selected IFC to pre-heat or pre-cool to the target temperature based on receiving the food product information. In some such embodiments, the computing device (e.g., of a user device utilizing a corresponding software application or of the IFC directly) may determine that the target temperature or temperature band has been reached and cause a corresponding alert or notification to indicate that pre-heating is complete. In some embodiments, the alert or notification may comprise illumination of an LED on the user interface of the IFC, such as similar to a beacon request described herein. Additionally or alternatively, a message may be sent to one or more devices/systems (e.g., a user device (such as a third-party user device or a restaurant user device), a server, a POS system, etc.) to indicate that pre-heating (or pre-cooling) has been completed. In some such embodiments, the corresponding IFC number may be included (e.g., “IFC No. 3 is pre-heated for Order No. 52”). In some embodiments, other alerts or notifications are contemplated.

In some embodiments, the computing device may determine an estimated completion time for the food products of the delivery and cause the IFC to pre-heat or pre-cool, such that the IFC is at the target temperature at the estimated completion time. The computing device may receive the user input defining a food product, such as though the user interface or from a POS device. The computing device may determine an estimated completion time based on the food product. For example, the computing device may access a memory including a table having completion time values for the food products. The computing device may then select the lowest or highest completion time and cause the IFC to control the electrical power supplied to at least one of the fan 38 or the heating/cooling element, such that the temperature of the food chamber 34 is within the target temperature band at the estimated completion time. In some example embodiments, the user interface of the IFC 30 may display a pre-heating or pre-cooling status, such as yellow indicating pre-heating or pre-cooling and green indicating that the IFC is at the target temperature.

In some example embodiments, the processing circuitry 42 may be configured to determine a power supply status, such as a charge level, whether the power supply is charging, whether it is plugged in, among other things. In some embodiments, in response, the processing circuitry 42 may cause the user interface 52 of the IFC 30 to indicate the power supply status. The indications of power supply status may include, without limitation, a green light to indicate that the power supply is charged greater than a first threshold, such as 80 percent, a yellow light to indicate that the power supply is charged less than a second threshold such as 50 percent, and a red light to indicate that the power supply is charged less than a third threshold, such as 20 percent. Additionally or alternatively, the indications of power supply status may include a green blinking light for when the power supply is plugged in and a blinking red light for indicating that wireless charging is occurring. In some embodiments including an LCD display, the user interface may include a charge value and/or status icons, such as battery bars. Similarly, the power supply status data may be transmitted to the computing device to be displayed in the IFC control user interface 200 (e.g., the software application).

As detailed above, in some example embodiments, the food packages 70 may include an identifier 71 and the IFC 30 may include an identifier reader 45. In some such embodiments, a PUS may associate the identifier with a food product of an order, such as by printing a label including the identifier 71 that is then affixed to the food package 70. Additionally or alternatively, the identifier may be embedded or printed on the food package. In some example embodiments, the PUS or identifier reader associated with the POS may write identifier data to the identifier 71. The identifier data may include, for example, the food product or type of food product, a target temperature (or temperature band) for the food product, a delivery location, an order number and/or inventory, or other useful data.

In some example embodiments, the identifier reader 45 may be configured to read the identifiers 71 associated with the food packages 70 as the food packages are placed within the food chamber 34. For example, labels, such as barcodes, QR codes, and character codes, may be read as the products are placed within the food chamber by an identifier reader 45 disposed in the top wall 32. In some example embodiments in which the identifier reader 45 is an RFID reader, the identifier reader may periodically interrogate identifiers 71, e.g. RFID tags, within the food chamber. The RFID reader may be disposed in any of the insulated walls, for example the bottom wall 32B between power supplies 40. The identifier reader 45 may communicate the identification data to processing circuitry 42.

Processing circuitry 42 may be configured to, in some embodiments, determine an order status based on the identification data. The processing circuitry 42 may receive an order inventory from the POS or as a portion of the identification data. The processing circuitry may compare the food products identified in the identification data to the inventory list to determine if the order status is complete or incomplete. The processing circuitry 42 may transit the order status to the POS (or other remote computing device) for display. Additionally or alternatively, the processing circuitry 42 may cause the user interface 52 of the IFC 30 to indicate the order status, such as illuminating a green LED for the order being complete or a red LED for the order being incomplete.

In some example embodiments, the processing circuitry 42 may be configured to determine a target temperature or target temperature band based on the identification data. As discussed above, the identification data may include the target temperature or temperature band. Additionally or alternatively, the identification data may include a temperature identifier or food product identifier. The processing circuitry 42 may be configured to access a temperature look up table, such as stored in memory, and determine the target temperature or temperature band based on the temperature identifier or food product identifier. In response to determining the target temperature or temperature band, the processing circuitry 42 may cause the IFC 30 to control the electrical power supplied to at least one of the fan 38 or the heating/cooling element, so as to cause the temperature of the food chamber to stay at the target temperature or within the temperature band.

In some example embodiments, the identifier reader 45 may also be configured to write information to the identifier 71 associated with the food package 70. For example, the identifier reader 45 may write a target temperature or temperature band, an actual temperature, a time placed within the food chamber, or the like to an identifier 71 associated with one or more of the food packages 70 within the food chamber 34. In such an example configuration, the identifier 71 may carry some such information that can be accessed by a customer to determine or track such various information about the food package. For example, a customer may be able to verify that the food package maintained a certain temperature during delivery.

In some example embodiments, the IFCs 30 may be configured to be remotely deactivated. Such a remote deactivation may occur from a remote server or through the above described software application. In some embodiments, the IFCs may be subject to a subscription service that enables use of the IFC for subscribers. In some cases of delinquent payment or shutting off of the subscription, a remote server may be configured to remotely deactivate the IFC (or certain functionality of the IFC). Additional example events that may warrant remote shut off may include theft or being lost, among others. In some such embodiments, a computing device may receive a user input identifying an IFC 30 to deactivate. The computing device may transmit a deactivation request to the identified IFC 30. The processing circuitry 42 of the IFC 30 may then cause electrical power from the power supply 40 to be disabled to the fan 38 and/or heating/cooling element, such that the IFC 30 does not maintain a target temperature. Additionally or alternatively, other IFC features may be disabled including the beacon, power supply charging, identifier reading, or the like.

### Example System Architecture

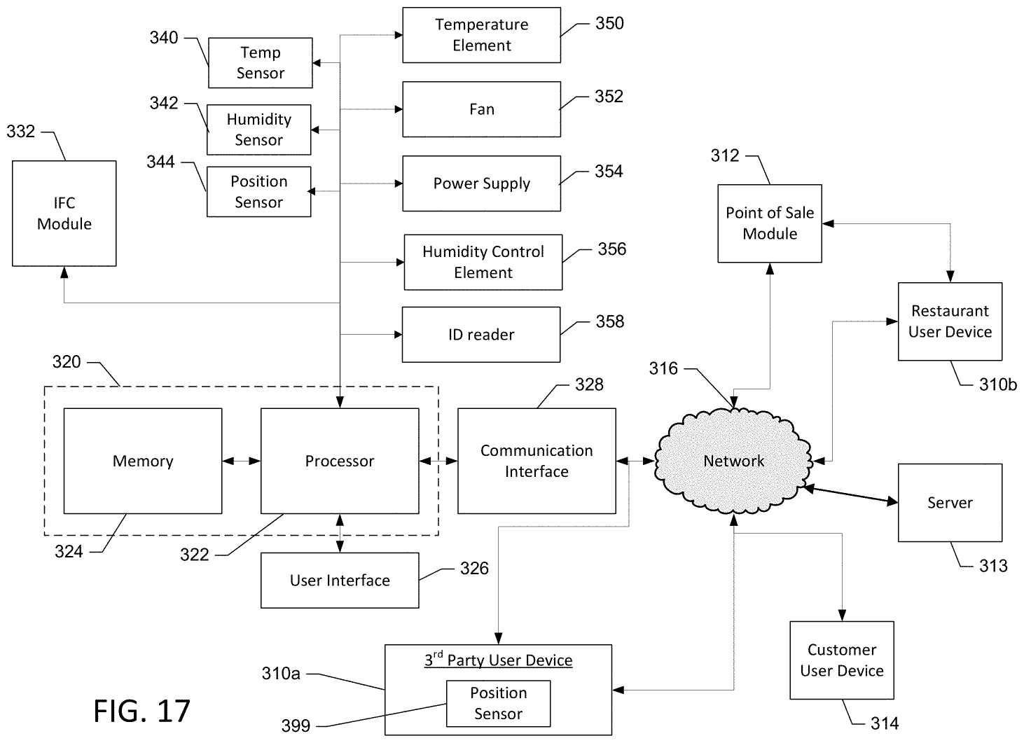

FIGS. 16-17 illustrate example systems/environments in which some example embodiments of the present invention may be employed. The system may include one or more user devices 310, IFCs 311, Point-of-Sale (POS) devices 312, servers 313, or customer devices 314. Each one of the user devices 310, IFCs 311, POS devices 312, servers 313, or customer devices 314 may include or otherwise be embodied as a computing device (e.g. a computer, a network access terminal, a personal digital assistant (PDA), tablet computer, wearable computer, smart phone, or the like) capable of communication with a network 316. As such, for example, each one of the user devices 310, IFCs 311, POS devices 312, servers 313, or customer devices 314 may include (or otherwise have access to) memory for storing instructions or applications for the performance of various functions described herein and a corresponding processor or processing circuitry 320 for executing stored instructions or applications described herein. Each one of the user devices 310, IFCs 311, POS devices 312, servers 313, or customer devices 314 may also include software and/or corresponding hardware for enabling the performance of the respective functions of system, as described herein.

In some example embodiments, one or more of the user devices 310, IFCs 311, POS devices 312, servers 313, or customer devices 314 may include a client application configured to operate in accordance with an example embodiment of the present invention. In this regard, for example, the client application may include software for enabling a respective one of the user devices 310, IFCs 311, POS devices 312, servers 313, or customer devices 314 to communicate with the network 316 for requesting and/or receiving information and/or services via network 316. Moreover, in some embodiments, the information or services that are requested via the network may be provided in software as a service (SAAS) environment. The information or services receivable at the client applications may include deliverable components (e.g. downloadable software to configure the user device 310, or information for consumption/processing at the user device 310).

Network 316 may be a data network, such as a local area network (LAN), a metropolitan area network (MAN), a wide area network (WAN) (e.g. the Internet), and/or the like, which may couple user device 310 to devices such as processing elements (e.g. personal computers, server computers, or the like) and/or databases. Communication between network 316, user device 310 and the devices or databases (e.g. servers) to which user device 310 are coupled may be accomplished by either wireline or wireless communication mechanisms and corresponding communication protocols.

In some example embodiments, devices to which user devices 310, IFCs 311, POS devices 312, servers 313, or customer devices 314 may be coupled via network 316 may include one or more servers, e.g. application servers 318 and/or database servers 319. It is noted that the example embodiment of the system discussed herein is scalable to inclusion of any number of user devices 310, IFCs 311, POS devices 312, servers 313, or customer devices 314. Although application server 318 and database server 319 are each referred to as “servers,” this does not necessarily imply that they are embodied on separate servers or devices. As such, for example, a single server or device may include both entities and database server 319 could merely be represented by a database or group of databases physically located on the same server or device as application server 318.

Application server 318 and database server 319 may each include hardware and/or software for configuring application server 318 and database server 319, respectively, to perform various functions. As such, for example, application server 318 may include processing circuitry 320, including a processor and memory enabling application server 318 to access and/or execute stored computer readable instructions for performing various functions. In an example embodiment, one function that may be provided by application server 318 may be the provision of access to information and/or services related to operation of the terminals or computers with which user device 310 is associated. For example, application server 318 may be configured to provide for storage of information descriptive of food temperatures, delivery routes, delivery locations, or the like. In some cases, such contents may be stored in database server 319. Alternatively or additionally, application server 318 may be configured to provide analytical tools for use by the user devices 310, IFCs 311, POS devices 312, servers 313, or customer devices 314 in accordance with example embodiments.

In some embodiments, for example, application server 318 may therefore include an instance of an IFC module 332, such as shown in FIG. 17, comprising stored instructions for handling activities associated with practicing example embodiments as described herein. As such, in some embodiments, user devices 310, IFCs 311, or POS devices 312 may access the IFC module 332 online and utilize the services provided thereby. However, it should be appreciated that in other embodiments, IFC module 332 may be provided from application server 318 (e.g. via download over network 316) to one or more of the user devices 310, IFCs 311, or POS devices 312 to enable recipient use devices to instantiate an instance of IFC module 332 for local operation. As yet another example, IFC module 332 may be instantiated at one or more of the user devices 310, IFCs 311, or POS devices 312 responsive to downloading instructions from a removable or transferable memory device carrying instructions for instantiating IFC module 332 at the corresponding one or more of the user devices 310, IFCs 311, or POS devices 312. In such an example, network 316 may, for example, be a peer-to-peer (P2P) network where one of the user devices includes an instance of the IFC module 332 to enable the corresponding one of the user devices to act as a server to other user devices 310, IFCs 311, or POS devices 312. In a further example embodiment, IFC module 332 may be distributed amongst one or more user devices 310, IFCs 311, POS devices 312, IFC server 313, and/or application server 318.

In some example embodiments, application server 318 may include or have access to memory (e.g. internal memory or database server 319) for storing instructions or applications for the performance of various functions and a corresponding processor for executing stored instructions or applications. For example, the memory may store an instance of an IFC module 332 configured to operate in accordance with various example embodiments of the present invention. In this regard, for example, the IFC module 332 may include software for enabling application server 318 to communicate with network 316, user devices 310, IFCs 311, POS devices 312, servers 313, or customer devices 314 for the provision and/or receipt of information associated with performing activities as described herein. Moreover, in some embodiments, application server 318 may include or otherwise be in communication with an access terminal (e.g. a computer including a user interface) via which a user may interact with, configure, or otherwise maintain the system.

In some example embodiments, with reference to FIG. 17, the IFC may include or otherwise be in communication with processing circuitry 320 that is configured to perform data processing, application execution and other processing and management services according to various example embodiments of the present invention. In some embodiments, processing circuitry 320 may include a memory 324 and a processor 322 that may be in communication with or otherwise control a user interface 326 and a communication interface 328. As such, processing circuitry 320 may be embodied as a circuit chip (e.g. an integrated circuit chip) configured (e.g. with hardware, software or a combination of hardware and software) to perform operations described herein. However, in some embodiments, processing circuitry 320 may be embodied as a portion of a server, computer, laptop, workstation or even one of various mobile computing devices. In situations where processing circuitry 320 is embodied as a server or at a remotely located computing device, user interface 326 may be disposed at another device (e.g. at a computer terminal or client device) that may be in communication with processing circuitry 320 via the device interface 328 and/or a network (e.g. network 316).

In some example embodiments, processor 322 (or processing circuitry 320) may be embodied as, include, or otherwise control the IFC module 332. Accordingly, the IFC module 332 may be any device or circuitry operating in accordance with software or otherwise embodied in hardware or a combination of hardware and software (e.g. processor 322 operating under software control, processor 322 embodied as an ASIC or FPGA specifically configured to perform the operations described herein, or a combination thereof) thereby configuring the device or circuitry to perform the corresponding functions of IFC module 332, as described herein.

Processor 322 may be embodied in a number of different ways. For example, processor 322 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In some example embodiments, processor 322 may be configured to execute instructions stored in the memory 324 or otherwise accessible to processor 322. As such, whether configured by hardware or software methods, or by a combination thereof, processor 322 may represent an entity (e.g. physically embodied in circuitry) capable of performing operations according to embodiments of the present invention while configured accordingly. Thus, for example, when processor 322 is embodied as an ASIC, FPGA or the like, processor 322 may be specifically configured hardware for conducting the operations described herein. Alternatively, as another example, when processor 322 is embodied as an executor of software instructions, the instructions may specifically configure processor 322 to perform the operations described herein.

In some example embodiments, the memory 324 may include one or more non-transitory storage or memory devices such as, for example, volatile and/or non-volatile memory that may be either fixed or removable. Memory 324 may be configured to store information, data, applications, instructions or the like for enabling the apparatus to carry out various functions in accordance with example embodiments of the present invention. For example, memory 324 could be configured to buffer input data for processing by processor 322. Additionally or alternatively, memory 324 could be configured to store instructions for execution by processor 322. As yet another alternative, memory 324 may include one of a plurality of databases (e.g. database server 319) that may store a variety of files, contents or data sets. Among the contents of memory 324, applications (e.g. client applications or service application) may be stored for execution by processor 322 in order to carry out the functionality associated with each respective application.

User interface 326 may be an input/output device for receiving instructions directly from a user. User interface 326 may be in communication with processing circuitry 320 to receive user input via user interface 326 and/or to present output to a user as, for example, audible, visual, mechanical or other output indications. User interface 326 may include, for example, a keyboard, a mouse, a joystick, a display (e.g. a touch screen display), one or more indicators (e.g. LEDs), a microphone, a speaker, or other input/output mechanisms. Further, processing circuitry 320 may comprise, or be in communication with, user interface circuitry configured to control at least some functions of one or more elements of user interface 326. Processing circuitry 320 and/or user interface circuitry may be configured to control one or more functions of one or more elements of user interface 326 through computer program instructions (e.g. software and/or firmware) stored on a memory device accessible to processing circuitry 320 (e.g. volatile memory, non-volatile memory, and/or the like). In some example embodiments, the user interface circuitry is configured to facilitate user control of at least some functions of the apparatus through the use of a display configured to respond to user inputs. Processing circuitry 320 may also comprise, or be in communication with, display circuitry configured to display at least a portion of user interface 326. In such a regard, the display and the display circuitry may be configured to facilitate user control of at least some functions of the IFC.

Communication interface 328 may be any device or circuitry embodied in either hardware, software, or a combination of hardware and software that is configured to receive and/or transmit data from/to a network and/or any other device or module in communication with the apparatus. Communication interface 328 may also include, for example, an antenna (or multiple antennas) and supporting hardware and/or software for enabling communications with network 316 or other devices (e.g. user device 310). In some environments, communication interface 328 may alternatively or additionally support wired communication. As such, for example, communication interface 328 may include a communication modem and/or other hardware/software for supporting communication via cable, digital subscriber line (DSL), universal serial bus (USB) or other mechanisms. In some embodiments, communication interface 328 may support communication via one or more different communication protocols or methods. In some cases, IEEE 802.15.4 based communication techniques such as ZigBee or other low power, short range communication protocols, such as a proprietary technique based on IEEE 802.15.4 may be employed along with radio frequency identification (RFID) or other short range communication techniques (e.g., Bluetooth).

In some example embodiments, the processing circuitry 320 may include or be in communication with a temperature sensor 340. The temperature sensor 340 may be configured to measure the air temperature of a food chamber of an IFC 311. The temperature sensor 340 may include a thermocouple, a thermistor, a resistance thermometer, or any other suitable temperature measurement sensor.

In some example embodiments, the processing circuitry 320 may include or be in communication with a humidity sensor 342. The humidity sensor 342 may be configured to measure the humidity of a volume of air in a food chamber of an IFC 311. The humidity sensor 342 may be a capacitive sensor, a resistive sensor, or a thermal conductivity sensor, or other suitable humidity measuring sensor.

In some example embodiments, the processing circuitry 320 may include or be in communication with a position sensor 344. The position sensor 344 may be configured to measure one or more values for a location determination. The position sensor 344 may include a global position system (GPS) sensor, radio frequency identification (RFID) sensor, cellular signal sensor, or other suitable sensor for location determination or location based service (LBS).

In some example embodiments, the processing circuitry 320 may include or be in communication with a temperature element 350. The temperature element 350 may be configured to provide heat, cooling, or both to control the temperature of the food chamber to maintain a predetermined temperature or predetermined temperature band. In some example embodiments, the temperature element 350 may include a heating element, such as a resistive coil, a silicone heat pad, or other suitable heat source. In some example embodiments, the temperature element 350 may include a cooling element, such as a refrigeration unit. In some example embodiments, the temperature element 350 comprises both a heating element and cooling element. For example, the temperature element 350 may include both a resistive coil and a refrigeration unit. In some example embodiments, the temperature element 350 may comprise a thermoelectric generator (TEG) configured to provide both heating and cooling based on the direction of current flow through the TEG.

In some example embodiments, the processing circuitry 320 may include or be in communication with a fan 352. The fan 352 may circulate air within the food delivery container such as through the climate control system into the food chamber. The fan may be an axial flow fan, a centrifugal fan (e.g. blower), or a cross-flow fan.

In some example embodiments, the processing circuitry 320 may include or be in communication with a power supply 354. The power supply 354 may provide electrical power to the processing circuitry 320, the fan 352, the temperature element 350, or the like. The power supply 354 may be a rechargeable power supply including without limitation a rechargeable battery, such as cylindrical batteries or flat pack batteries, a capacitor, such as a super capacitor, or other suitable power source.

In some example embodiments, the processing circuitry 320 may include or be in communication with a humidity control element 156, such as a flow valve in communication with a humidity element. In such an example embodiment, the flow valve may be configured to enable or limit air flow to, or through, a humidity element. In an example embodiment, a flow valve may be a louver, or other suitable air flow restrictor.

In some example embodiments, the processing circuitry 320 may include or be in communication with an identifier (ID) reader 358. The identifier reader 358 may include a barcode reader, quick response (QR) code reader, a character reader, an RFID reader, an energy quality reader (e.g., a device for metering and measuring electrical energy quality) or the like. The identifier reader 358 may be configured to read an identifier or other data associated with one or more food packages placed into the food chamber. In some example embodiments, the identifier reader 358 may also be configured to write information to the identifier associated with the food package, such as a target temperature, an actual temperature, a time placed within the food chamber, among other things, such as described herein.

IFC module 332 may include tools to facilitate food delivery monitoring and control via network 316. In some example embodiments, IFC module 332 may be configured to receive temperature data indicative of the internal temperature of a food chamber of one or more IFCs 311 and control, for at least one IFC 311, the electrical power supplied to at least one of a fan 352 or a temperature element 350 to maintain a temperature of the food chamber, such as described herein.

Further examples of various functions and embodiments are illustrated by the systems/environments shown in FIGS. 16 and 17. In this regard, the IFC and the various contemplated devices and servers may interact and communicate as needed to facilitate the various contemplated functions described herein.

As an example, in some embodiments, a third-party user device, such as a smartphone of a delivery driver may be utilized for certain functionality of the IFC. For example, instead of utilizing a position sensor 344 on the IFC, the third-party user device 310a may include a position sensor 399 that can be utilized for various features, such as boost mode or beacon mode. In this regard, the position sensor on the smartphone of the delivery driver may be leveraged (which may allow removal or non-inclusion of the position sensor 344—such as to reduce costs). In some embodiments, both position sensors may be utilized to enable confirmation of location. In some embodiments, the third-party user device 310 may run various software applications, such as the software application described with respect to FIGS. 15A-15C. In some embodiments, certain functionality of the software application may be enabled or disabled for a smartphone application on the third-party user device 310a. Further, in some embodiments, the third-party user device 310a may communicate directly (such as through Bluetooth or other communication mode) with the IFC.

As another example, a restaurant user device 310b may utilize various functionality described herein, such as the software application described with respect to FIGS. 15A-15C. Further, the restaurant user device 310b may communicate, in some embodiments, directly (such as through Bluetooth or other communication mode) with a point of sale module 312, such as to facilitate various functionality—such as order completion checking or pre-heating functionality.

As a further example, a customer user device 314 may be an example end user's device, such as the smartphone of a person ordering food. One or more of the IFC, third-party user device 310a, restaurant user device 310b, point of sale module 312, or server 313 may communicate with the customer user device 314 to provide information regarding the delivery or order (e.g., updates on the order status, estimated delivery time, etc.).

As yet another example, a server 313 may interact with one or more of the devices/modules/systems to facilitate various functionality described herein. For example, the server 313 may enable or disable operations, such certain features facilitated by the software application or directly on the IFC—such as in response to termination of a subscription.

### Example Flowcharts

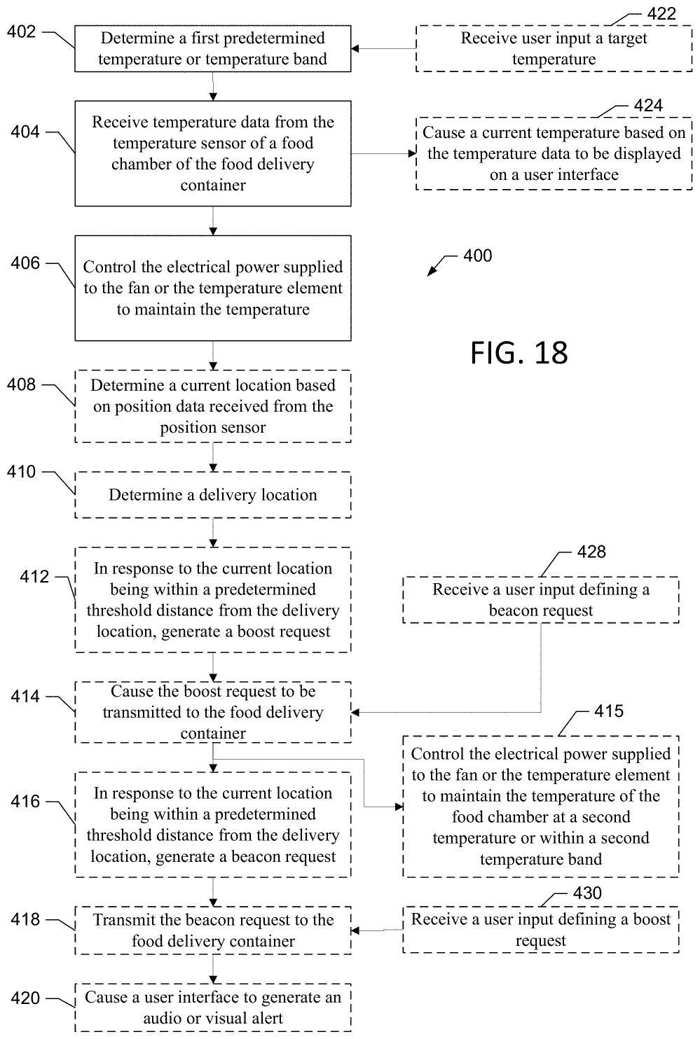

FIGS. 18-22 illustrate flowcharts corresponding to various functions and/or methods of various example embodiments of the present invention, such as described herein. In some embodiments, processing circuitry 320 (which may include a processor capable of executing instructions stored in a non-transitory computer readable medium/memory) may be configured to implement various control algorithms corresponding to such flowcharts, or portions thereof.

With reference to FIG. 18, an example method 400 for controlling an IFC may include determining a first temperature or temperature band for maintaining the food chamber at operation 402. Then, at operation 404, the method may include receiving temperature data from the temperature sensor configured to measure a temperature of a food chamber of the food delivery container. Further, the method may include controlling the electrical power supplied to the fan or the temperature element to maintain the temperature of the food chamber at the first temperature or within the first predetermined temperature band at operation 406.

In some embodiments, the method may include additional, optional operations, and/or the operations described above may be modified or augmented. Some examples of modifications, optional operations, and augmentations are described below, as indicated by dashed lines, such as, determining a current location based on position data received from the position sensor at operation 408, determine a delivery location at operation 410. The method may also include generating a boost request in response to the current location being within a predetermined threshold distance from the delivery location at operation 412, causing the boost request to be transmitted to the food delivery container at operation 414, and controlling the electrical power supplied to the fan or the temperature element to maintain the temperature of the fbod chamber at a second temperature or within a second temperature band at operation 415. The method may further include generating a beacon request in response to the current location being within a predetermined threshold distance from the delivery location at operation 416, transmitting the beacon request to the food delivery container at operation 418, and causing a user interface to generate an audio or visual alert at operation 420. The method may also include receiving user input a target temperature or temperature band at operation 422, and causing a current temperature based on the temperature data to be displayed on a user interface at operation 424. In some example embodiments, the method includes receiving a user input defining a beacon request at operation 428, and receiving a user input defining a boost request at operation 430.

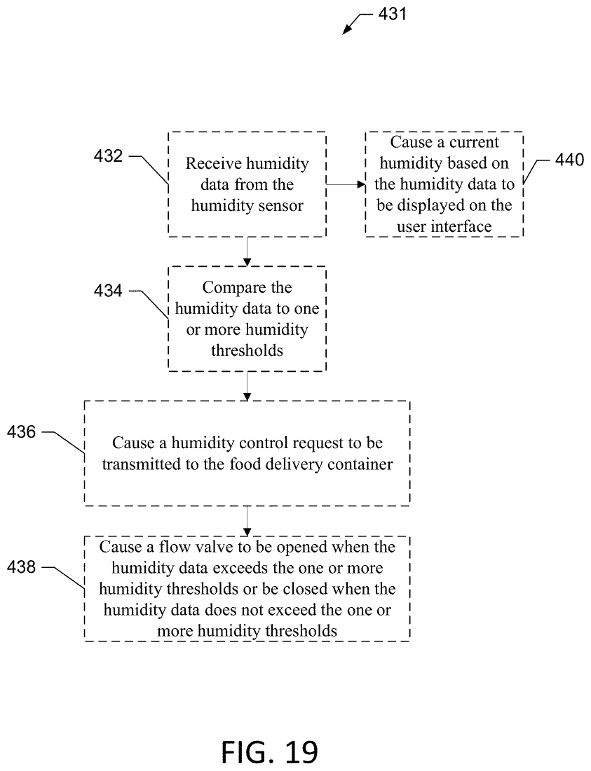

With reference to FIG. 19, an example method 431 for determining and/or controlling humidity in the IFC is shown. The method may include receiving humidity data from the humidity sensor at operation 432, comparing the humidity data to one or more humidity thresholds at operation 434, causing a humidity control request to be transmitted to the food delivery container at operation 436, and causing a flow valve to be opened when the humidity data exceeds the one or more humidity thresholds or be closed when the humidity data does not exceed the one or more humidity thresholds at operation 438. In some embodiments, the method includes causing a current humidity based on the humidity data to be displayed on the user interface at operation 440.

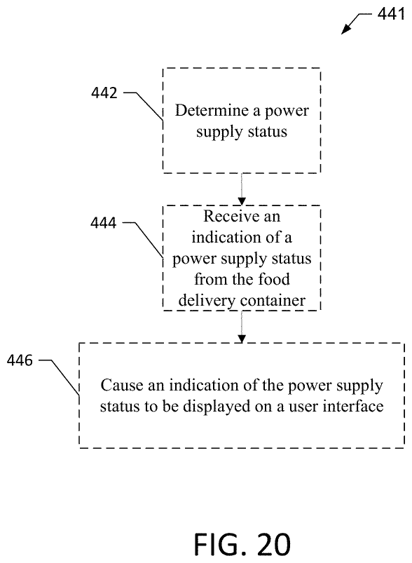

With reference to FIG. 20, an example method 441 for determining and/or displaying a power supply status for an IFC is shown. The method may include determining a power supply status at operation 442, receiving an indication of a power supply status from the food delivery container at operation 444, and causing an indication of the power supply status to be displayed on a user interface at operation 446.

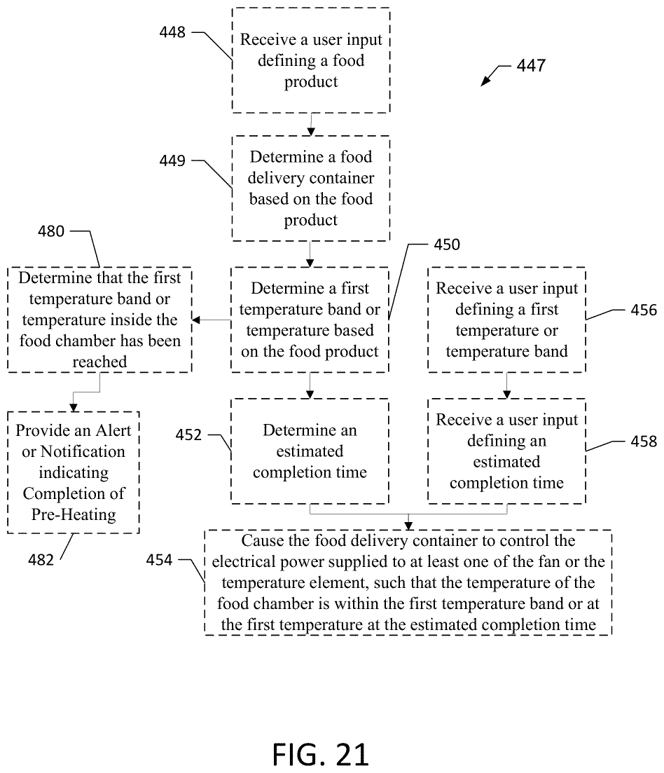

With reference to FIG. 21, an example method 447 for determining and/or pre-heating or pre-cooling an IFC is shown. The method may include receiving a user input defining a food product at operation 448, determining a food delivery container based on a food size and/or other factors associated with the food product at operation 449, determining a first temperature band or temperature based on the food product at operation 450, determining an estimated completion time for completing the food product at operation 452, and causing the food delivery container to control the electrical power supplied to at least one of the fan or the temperature element, such that the temperature of the food chamber is within the first temperature band or at the first temperature at the estimated completion time at operation 454. In some example embodiments, the method may include receiving a user input defining a first temperature band or first temperature at operation 456 and receiving a user input defining an estimated completion time at operation 458.

In some example embodiments, the method may include determining that the first temperature or first temperature band has been reached inside the food chamber at operation 480 and causing an alert or notification indicating that pre-heating has completed at operation 482. In some such embodiments, the method may not include determining an estimated completion time and, instead, may just indicate when the pre-heating is complete. Depending on the configuration of the systems, the alert or notification may include any alert or notification (such as on the IFC directly, through the software application, or otherwise). For example, an LED may illuminate on the IFC to indicate which IFC is pre-heated and ready for insertion of the order.

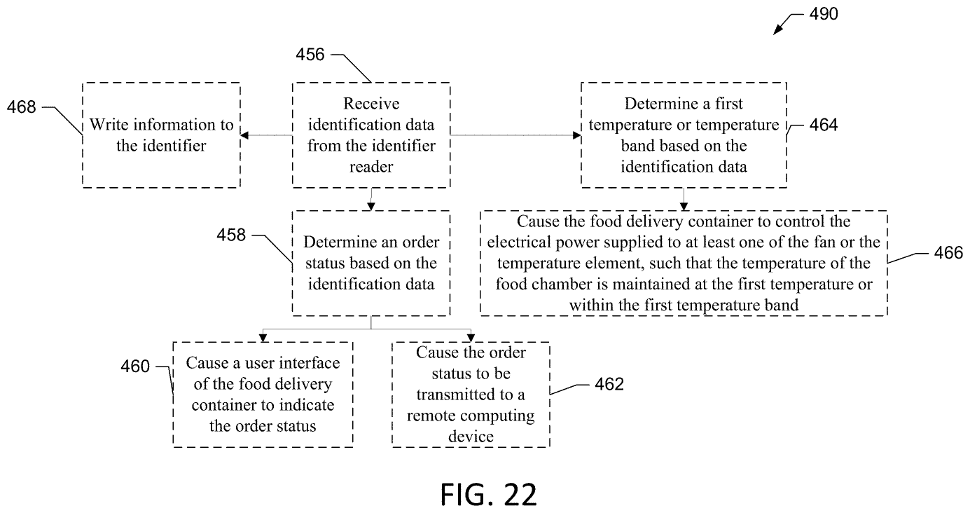

With reference to FIG. 22, an example method 490 for utilizing an identifier reader with an IFC is shown. The method may include receiving identification data from the identifier reader at operation 456, determining an order status based on the identification data at operation 458, causing a user interface associated with the food delivery container to indicate the order status at operation 460, and/or causing the order status to be transmitted to a remote computing device at operation 462. In some example embodiments, the method may include determining a first temperature or temperature band based on the identification data at operation 464 and causing the food delivery container to control the electrical power supplied to at least one of the fan or the temperature element, such that the temperature of the food chamber is maintained at the first temperature or within the first temperature band at operation 466. In some example embodiments, the method may include writing information to the identifier at operation 468.

### CONCLUSION

Many modifications and other embodiments of the inventions set forth herein may come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A food delivery container comprising:
a plurality of insulated walls that form a food chamber, wherein at least one of the insulated walls is movable between a closed position and an open position to enable food to be placed within or removed from the food chamber; and
a climate control system positioned within one of the plurality of insulated walls, wherein the climate control system comprises:
an air flow pathway;
a temperature control element positioned within the air flow pathway;
a fan in air flow communication with the food chamber through a first inlet opening and a first outlet opening in the one of the plurality of insulated walls, wherein the fan is configured to draw in air from the food chamber through the first inlet opening and push air into the food chamber through the first outlet opening such that air travels through the air flow pathway and over the temperature control element to circulate temperature controlled air within the food delivery container; and
a power supply configured to supply electrical power to the fan and the temperature control element.

2. The food delivery container of claim 1 further comprising:
a temperature sensor configured to measure a temperature of the food chamber;
a processor; and
a memory including computer program code configured to cause the processor to:
receive temperature data from the temperature sensor; and
control the electrical power supplied to at least one of the fan or the temperature control element to maintain the temperature of the food chamber either at a first predetermined temperature or within a first predetermined temperature band.

3. The food delivery container of claim 2 further comprising:
a position sensor, and
wherein the computer program code is further configured to cause the processor to:
determine a current location based on position data received from the position sensor;
determine a delivery location;
compare the current location to the delivery location; and
in response to determining that the current location is within a predetermined threshold distance from the delivery location, control the electrical power supplied to at least one of the fan or the temperature control element to maintain the temperature of the food chamber either at a second predetermined temperature or within a second predetermined temperature band, wherein the second predetermined temperature band is higher than the first predetermined temperature band or the second predetermined temperature is higher than the first predetermined temperature.

4. The food delivery container of claim 2, wherein the computer program code is further configured to cause the processor to:
receive a boost request from a remote computing device; and
control the electrical power supplied to at least one of the fan or the temperature control element to maintain the temperature of the food chamber either at a second predetermined temperature or within a second predetermined temperature band, wherein the second predetermined temperature band is higher than the first predetermined temperature band or the second predetermined temperature is higher than the first predetermined temperature.

5. The food delivery container of claim 2, wherein the computer program code is further configured to cause the processor to:
receive a user input defining a food product;
determine the first predetermined temperature or the first predetermined temperature band based on the food product;
control the electrical power supplied to at least one of the fan or the temperature control element such that the temperature of the food chamber is either brought to or maintained at the first predetermined temperature or within the first predetermined temperature band; and
cause, in response to determining that the temperature of the food chamber has reached the first predetermined temperature or the first predetermined temperature band, an alert or notification to indicate that the temperature of the food chamber has reached the first predetermined temperature or the first predetermined temperature band.

6. The food delivery container of claim 2, wherein the computer program code is further configured to cause the processor to:
receive a user input defining the first predetermined temperature or the first predetermined temperature band;
determine an estimated completion time corresponding to when the food product will be ready for placement into the food chamber; and
control the electrical power supplied to at least one of the fan or the temperature control element such that the temperature of the food chamber is either at the first predetermined temperature or within the first predetermined temperature band at the estimated completion time.

7. The food delivery container of claim 1 further comprising:
a position sensor, and
wherein the computer program code is further configured to cause the processor to:
determine a current location based on position data received from the position sensor;
determine a delivery location;
compare the current location to the delivery location; and
in response to determining that the current location is within a predetermined threshold distance from the delivery location, cause a user interface of the food delivery container to generate an audio or visual alert.

8. (canceled)

9. The food delivery container of claim 1 further comprising:
a processor; and
a memory including computer program code configured to cause the processor to:
receive a beacon request from a remote computing device; and
cause a user interface of the food delivery container to generate an audio or visual alert.

10. The food delivery container of claim 1, wherein the power supply comprises a rechargeable battery or capacitor that is capable of being recharged and providing electrical power.

11.-14. (canceled)

15. The food delivery container of claim 1 further comprising:
at least one heat conductor configured to disperse heat generated by the temperature control element or the power supply.

16.-20. (canceled)

21. The food delivery container of claim 1 further comprising:
a humidity control element configured to remove or add humidity to a volume of air within the food chamber to maintain either a predetermined humidity level or a predetermined humidity band.

22.-23. (canceled)

24. The food delivery container of claim 1 further comprising:
a food package support configured to be inserted within the food chamber, wherein the food package support comprises a plurality of food package receptacles defined by a plurality of receptacle walls, wherein the plurality of receptacle walls comprises two side walls disposed on opposite sides of the food package support, an upper wall, and lower wall for each of the plurality of food package receptacles, wherein the upper walls and lower walls of the plurality of food package receptacles comprise at least one flow hole enabling air flow through the food package support.

25. The food delivery container of claim 24, wherein the at least one flow hole is configured to be aligned with the first air outlet opening of the one of the plurality of insulated walls defining the food chamber.

26. The food delivery container of claim 24, wherein the food package support further comprises a plurality of pinch slots, wherein the plurality of pinch slots are configured to engage a food package to limit opening of the food package when inserted into one of the plurality of food package receptacles.

27.-31. (canceled)

32. The food delivery container of claim 1 further comprising:
an identifier reader configured to read a food package identifier associated with one or more food packages placed within the food chamber;
a processor; and
a memory including computer program code configured to cause the processor to:
receive identification data from the identifier reader.

33. The food delivery container of claim 32, wherein the computer program code is further configured to cause the processor to:
determine a first predetermined temperature or a first predetermined temperature band based on the identification data; and
cause the food delivery device to control the electrical power supplied to at least one of the fan or the temperature control element to maintain the temperature of the food chamber either at a first predetermined temperature or within a first predetermined temperature band.

34. The food delivery container of claim 32, wherein the computer program code is further configured to cause the processor to:
determine an order status based on the identification data by comparing the identification data with a planned order, wherein the planned order includes required meal components corresponding to a customer order scheduled for delivery using the food delivery container.

35.-37. (canceled)

38. The food delivery container of claim 1 further comprising:
one or more wall projections extending from at least one of the plurality of insulated walls into the food chamber, wherein the one or more wall projections are configured to enable complementary food packaging to be placed into the food chamber and limit or prevent non-complementary food packaging from being placed into the food chamber.

39.-41. (canceled)

42. A system comprising:
a food delivery container comprising:
a plurality of insulated walls that form a food chamber, wherein at least one of the insulated walls is movable between a closed position and an open position to enable food to be placed within or removed from the food chamber;
a temperature sensor configured to measure a temperature of the food chamber; and
a climate control system positioned within one of the plurality of insulated walls, wherein the climate control system comprises:
an air flow pathway;
a temperature control element positioned within the air flow pathway;
a fan in air flow communication with the food chamber through a first inlet opening and a first outlet opening in the one of the plurality of insulated walls, wherein the fan is configured to draw in air from the food chamber through the first inlet opening and push air into the food chamber through the first outlet opening such that air travels through the air flow pathway and over the temperature control element to circulate temperature controlled air within the food delivery container; and
a power supply configured to supply electrical power to the fan and the temperature control element; and
an application module stored on a computing device, the computing device comprising:
a processor; and
a memory including computer program code configured to cause the processor to:
receive temperature data from the temperature sensor; and
cause the food delivery container to control the electrical power supplied to at least one of the fan or the temperature control element to maintain the temperature of the food chamber at a first predetermined temperature or within a first predetermined temperature band.

43. The system of claim 42, wherein the computing device comprises a computing device that is separate from the food delivery container.

44. The system of claim 42, wherein the computing device comprises a point of sale computing device.

45. The system of claim 42, wherein the computing device comprises a mobile computing device.

46.-48. (canceled)

49. A method for controlling a food delivery container, the method comprising:
receiving temperature data from a temperature sensor configured to measure a temperature of a food chamber of the food delivery container, wherein the food delivery container comprises:
a plurality of insulated walls forming the food chamber, wherein at least one of the insulated walls is moveable between a closed position and an open position to enable food to be placed within or removed from the food chamber; and
a climate control system positioned within one of the plurality of insulated walls, wherein the climate control system comprises:
an air flow pathway
a temperature control element positioned within the air flow pathway;
a fan in air flow communication with the food chamber through a first inlet opening and a first outlet opening in the one of the plurality of insulated walls, wherein the fan is configured to draw in air from the food chamber through the first inlet opening and push air into the food chamber through the first outlet opening such that air travels through the air flow pathway and over the temperature control element to circulate temperature controlled air within the food delivery container; and
a power supply configured to supply electrical power to the fan and temperature control element: and
controlling the electrical power supplied to at least one of the fan or the temperature control element to maintain the temperature of the food chamber at a first predetermined temperature or within a first predetermined temperature band.

50.-70. (canceled)
